(19) United States
(12) Patent Application Publication
(10) Pub. No.: US 2026/0072474 A1
(43) Pub. Date: Mar. 12, 2026

(54) MULTI-FOLDABLE ELECTRONIC DEVICE

(71) Applicant: Samsung Electronics Co., Ltd., Suwon-si (KR)

(72) Inventors: Junyoung Choi, Suwon-si (KR); Jeongho Kang, Suwon-si (KR); Namwoo Kim, Suwon-si (KR); Minho Kim, Suwon-si (KR); Jihoon Kim, Suwon-si (KR); Minsuk Song, Suwon-si (KR); Soli Jung, Suwon-si (KR); Byounguk Yoon, Suwon-si (KR); Jaeyoung Jun, Suwon-si (KR); Jinug Choi, Suwon-si (KR)

(73) Assignee: Samsung Electronics Co., Ltd., Suwon-si (KR)

(21) Appl. No.: 19/244,702

(22) Filed: Jun. 20, 2025

Related U.S. Application Data
(63) Continuation of application No. PCT/KR2025/007113, filed on May 26, 2025.

(30) Foreign Application Priority Data
Sep. 11, 2024 (KR) 10-2024-0123799
Oct. 11, 2024 (KR) 10-2024-0138791

(51) Int. Cl. G06F 1/16

(52) U.S. Cl. CPC G06F 1/1656; G06F 1/1616; G06F 1/1652; G06F 1/1681

(57) ABSTRACT

An electronic device includes a housing. The housing includes a first housing part. The housing includes a second housing part rotatably coupled with the first housing part. The housing includes a third housing part rotatably coupled with the second housing part. The first housing part is configured to be positioned between the second housing part and the third housing part when the electronic device is in a multi-folded state. The electronic device includes a foldable display disposed to overlie the first housing part, the second housing part, and the third housing part.

### CROSS-REFERENCE TO RELATED APPLICATION(S)

This application is a continuation application, claiming priority under 35 U.S. C. § 365(c), of International Application No. PCT/KR2025/007113, filed on May 26, 2025, which is based on and claims priority to Korean Patent Application No. 10-2024-0123799, filed on Sep. 11, 2024, in the Korean Intellectual Property Office, and Korean Patent Application No. 10-2024-0138791, filed on Oct. 11, 2024, in the Korean Intellectual Property Office, the disclosures of each of which is incorporated by reference herein in its entirety.

### BACKGROUND

### 1. Field

The present disclosure relates to a multi-foldable electronic device.

### 2. Description of Related Art

A multi-foldable electronic device may include housing parts that are rotatably coupled, and a foldable display. The display may be bent according to a rotation of the housing parts. The multi-foldable electronic device may include two or more hinge assemblies that rotatably connect the housing parts. The two or more hinge assemblies may provide various states of the electronic device.

The above-described information may be provided as a related art for the purpose of helping to understand the present disclosure. No claim or determination is raised as to whether any of the above-described information may be applied as a prior art related to the present disclosure.

### SUMMARY

Aspects will be set forth in part in the description which follows and, in part, will be apparent from the description, or may be learned by practice of the presented embodiments.

An electronic device is provided. The electronic device may comprise a housing. The housing may comprise a first housing part. The housing may include a second housing part rotatably coupled with the first housing part. The housing may include a third housing part rotatably coupled with the second housing part. The first housing part may be configured to be positioned between the second housing part and the third housing part when the electronic device is in a multi-folded state. The electronic device may comprise a foldable display disposed to overlie the first housing part, the second housing part, and the third housing part. The first housing part may include a side wall defining a portion of a periphery of the electronic device. The first housing part may include a protection member supported by the side wall of the first housing part and disposed at a periphery of the foldable display. The third housing part may include a side wall parallel to the side wall of the first housing part. The third housing part may include at least one camera disposed in a rear surface of the third housing part. The third housing part may include at least one input member disposed in the side wall of the third housing part. The third housing part may include a buffer member disposed in the side wall of the third housing part. The buffer member may include a first buffer member disposed at a first position of the side wall of the third housing part and a second buffer member positioned at a second position of the side wall of the third housing part. The first buffer member and the second buffer member may be configured to protrude from the side wall of the third housing part.

An electronic device is provided. The electronic device may comprise a housing. The housing may include a first housing part. The housing may include a second housing part rotatably coupled with the first housing part. The housing may include a third housing part rotatably coupled with the second housing part. The first housing part may be configured to be positioned between the second housing part and the third housing part when the electronic device is in a multi-folded state. The electronic device may comprise a foldable display disposed above the first housing part, the second housing part, and the third housing part. The first housing part may include a first side wall defining a portion of a periphery of the electronic device. The first housing part may include a second side wall, defining a portion of the periphery of the electronic device, perpendicular to the first side wall of the first housing part. The first housing part may include a first protection member, supported by the first side wall of the first housing part, covering a portion of a periphery of the foldable display. The first housing part may include a second protection member. The second protection member may include a first portion supported by the second side wall of the first housing part, and a second portion, extending from the first portion of the second protection member, covering a portion of the periphery of the foldable display. The third housing part may include a side wall, defining a portion of the periphery of the electronic device, parallel to the first side wall of the first housing part. The third housing part may include a protection member, supported by the side wall of the third housing part, covering a portion of the periphery of the foldable display. The third housing part may include a buffer member protruded in a direction of the side wall of the third housing part. When the third housing part is positioned on a portion of the foldable display disposed above the first housing part in accordance with the second housing part partially folded with respect to both the first housing part and the third housing part, the buffer member may be contacted on the first portion of the second protection member of the first housing part.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A illustrates an example of a first state of an electronic device.

FIG. 1B illustrates an example of a second state of an electronic device.

FIG. 1C illustrates an example of a third state of an electronic device.

FIG. 2A is a plan view of an electronic device from which a flexible display is removed.

FIG. 2B is a rear view of an electronic device from which a rear cover and a display are removed.

FIG. 3 illustrates an electronic device having a triangular prism shape.

FIG. 4 illustrates a function executed by an electronic device having a triangular prism shape.

FIG. 5 illustrates an impact that may occur in relation to a display of an electronic device having a triangular prism shape.

FIG. 6 illustrates a damper included in a third housing part of an electronic device.

FIG. 7 illustrates a size of a damper included in a third housing part of an electronic device.

FIG. 8 illustrates a button included in a third housing part of an electronic device.

FIG. 9 illustrates a method of including a damper in a third housing part of an electronic device.

FIG. 10 illustrates a shape of a damper included in a third housing part of an electronic device.

FIG. 11 illustrates a first example configuration of an expanded front frame portion in a third housing part of an electronic device.

FIG. 12 illustrates a second example configuration of an expanded front frame portion in a third housing part of an electronic device.

FIG. 13 illustrates a third example configuration of an expanded front frame part in a third housing part of an electronic device.

FIG. 14 illustrates an example configuration of a side frame portion included in a third housing part of an electronic device.

FIG. 15 illustrates a size of a damper included in a third housing part of an electronic device that omits a front frame part.

FIG. 16 illustrates a damper capable of being inserted into a third housing part of an electronic device.

FIG. 17 illustrates a third housing part of an electronic device configured to be detachably attached to a first housing part of an electronic device.

FIG. 18 illustrates a shape of a side wall of a first housing part of an electronic device.

FIG. 19 illustrates a magnet included in a first housing part of an electronic device.

FIG. 20 illustrates a magnet in a third housing part of an electronic device paired with a magnet included in a first housing part of the electronic device.

FIG. 21 illustrates a stylus configured to be detachably attached through a magnet included in a first housing part of an electronic device.

FIG. 22 illustrates a groove included in a first housing part of an electronic device.

FIG. 23 illustrates a protruding portion of a third housing part of an electronic device paired with a groove included in a first housing part of the electronic device.

FIG. 24 is a block diagram of an electronic device in a network environment according to various embodiments.

### DETAILED DESCRIPTION

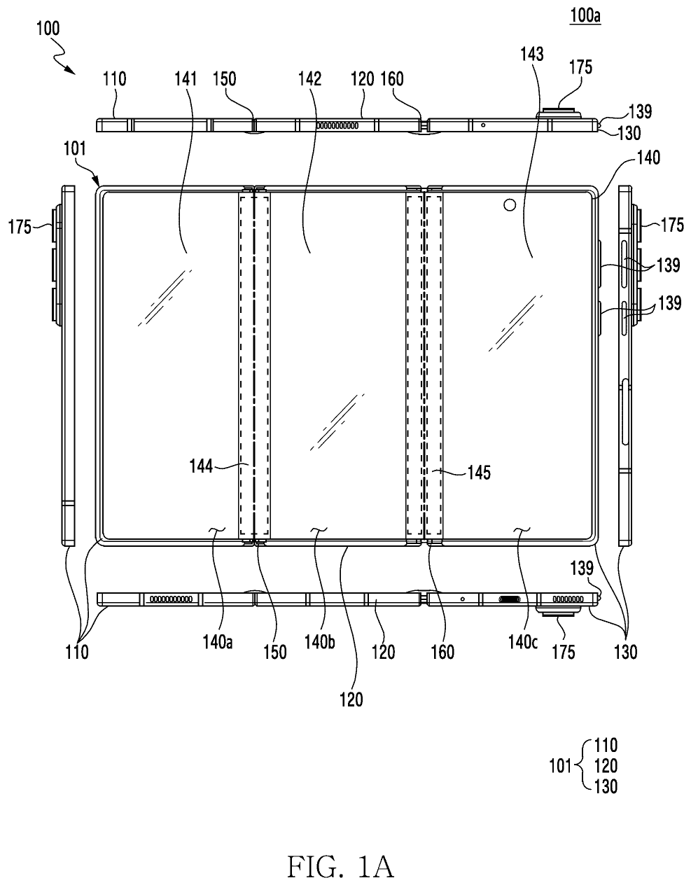

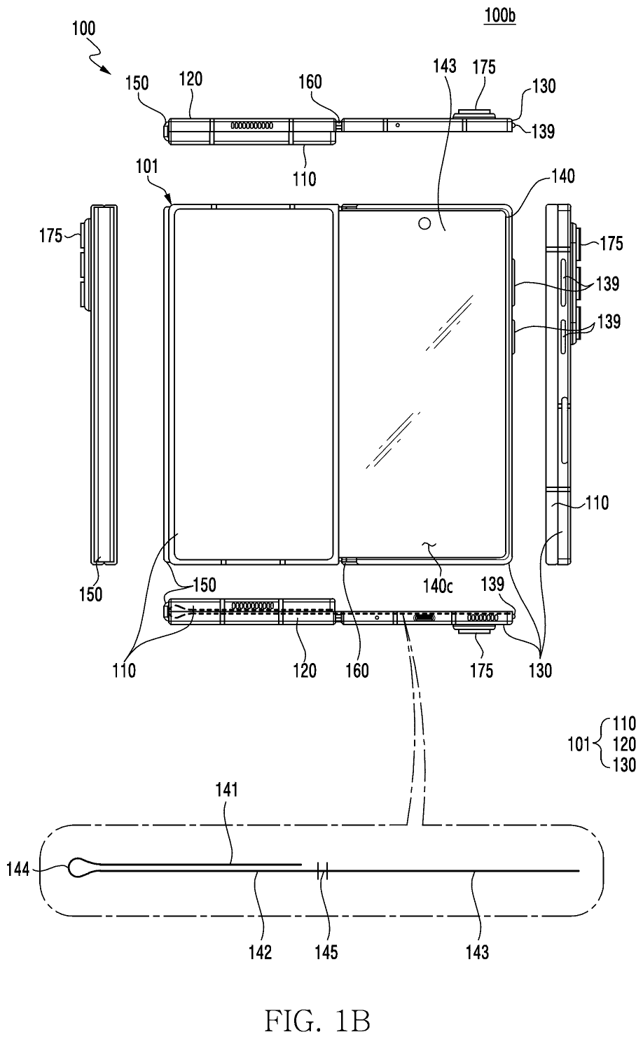

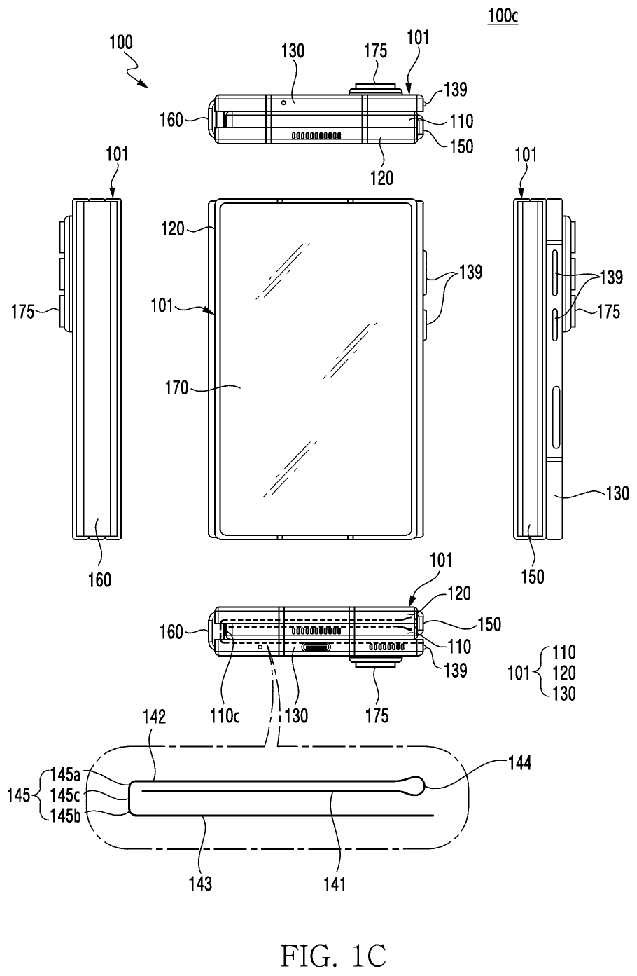

FIG. 1A illustrates an example of a first state of an electronic device. FIG. 1B illustrates an example of a second state of the electronic device. FIG. 1C illustrates an example of a third state of the electronic device.

Referring to FIGS. 1A, 1B, and 1C, an electronic device 100 may include a housing structure 101 (also referred to housing 101), a flexible display 140 (which may be described as a foldable display 140 or a main display 140), a first hinge structure 150, a second hinge structure 160, and a display 170 (which may be described as a sub-display 170). The housing structure 101 may include a first housing part 110, a second housing part 120, and a third housing part 130.

The first housing part 110 may be rotatably coupled to the second housing part 120 by the first hinge structure 150. The second housing part 120 and the first housing part 110 may be rotated with respect to the first hinge structure 150. While the first housing part 110 is rotated with respect to the first hinge structure 150, the second housing part 120 may be rotated with respect to the first hinge structure 150. For example, when the second housing part 120 and the first housing part 110 are rotated with respect to the first hinge structure 150, each displacement of the second housing part 120 may be substantially equal to each displacement of the first housing part 110.

The third housing part 130 may be rotatably coupled to the second housing part 120 by the second hinge structure 160. The second housing part 120 and the third housing part 130 may be rotated with respect to the second hinge structure 160. While the second housing part 120 is rotated with respect to the second hinge structure 160, the third housing part 130 may be rotated with respect to the second hinge structure 160. For example, when the second housing part 120 and the third housing part 130 are rotated with respect to the second hinge structure 160, each displacement (or each change) of the second housing part 120 may be substantially equal to each displacement of the third housing part 130.

The first hinge structure 150 and the second hinge structure 160 may change a state of the electronic device. The first hinge structure 150 and the second hinge structure 160 may provide (e.g., enable) a first state 100a of the electronic device 100 (or a first state 100a of the housing structure 101). The first state 100a of the electronic device 100 (or the first state 100a of the housing structure 101) may be described as an unfolded state of the electronic device 100 (or the housing structure 101). In the first state 100a, a front surface of the first housing part 110, a front surface of the second housing part 120, and a front surface of the third housing part 130 may define a front surface of the electronic device 100. In the first state 100a, the front surface of the first housing part 110, the front surface of the second housing part 120, and the front surface of the third housing part 130 may face the same direction. In the first state 100a, the electronic device 100 may provide, to a user, a large display region of the flexible display 140.

The first hinge structure 150 and the second hinge structure 160 may provide a second state 100b of the electronic device 100. The second state 100b of the electronic device 100 may be described as a state in which the electronic device 100 is partially folded and partially unfolded (or a single folding state or a half-folding state). For example, in the second state 100b, the front surface of the second housing part 120 and the front surface of the third housing part 130 may face the same direction, and the front surface of the first housing part 110 and the front surface of the second housing part 120 may face opposite directions. For example, in the second state 100b, the first housing part 110 and the second housing part 120 may be folded, and the second housing part 120 and the third housing part 130 may be unfolded. In the second state 100b, the electronic device 100 may provide visual information through a portion (e.g., a third display region 140c) of the flexible display 140.

The electronic device 100 may change from the first state 100a to a third state 100c through the second state 100b. The electronic device 100 may change from the first state 100a, which is an unfolded state, to the second state 100b, which is a partially unfolded state. For example, the electronic device 100 may change from the first state 100a in which the first housing part 110, the second housing part 120, and the third housing part 130 face the same direction to the second state 100b in which the front surface of the first housing part 110 faces the front surface of the second housing part 120. The electronic device 100 may change from the second state 100b, which is a partially unfolded state, to the third state 100c, which is a folded state. For example, when the second state 100b changes to the third state 100c, the first housing part 110 and the second housing part 120, which are folded, may be disposed on the third housing part 130.

The first hinge structure 150 and the second hinge structure 160 may provide a third state 100c of the electronic device 100 (or a third state 100c of the housing structure 101). The third state 100c of the electronic device 100 (or the third state 100c of the housing structure 101) may be described as a folded state (or a folding state or a multi-folding state) of the electronic device 100 (or the housing structure 101). In the third state 100c, the front surface of the first housing part 110 and the front surface of the second housing part 120 may face opposite directions, and the front surface of the second housing part 120 and the front surface of the third housing part 130 may face opposite directions. In the third state 100c, the front surface of the first housing part 110 and the front surface of the third housing part 130 may face the same direction. For example, in the third state 100c, the front surface of the second housing part 120 may face the front surface of the first housing part 110, and the front surface of the third housing part 130 may face a rear surface of the first housing part 110. In the third state 100c, a rear surface of the second housing part 120 may be exposed to the outside. The display 170 may be disposed on the rear surface of the second housing part 120. In the third state 100c, the rear surface of the third housing part 130 may be exposed to the outside. A camera 175 may be disposed on the rear surface of the third housing part 130. In the third state 100c, the electronic device 100 may be folded to improve portability, and may provide visual information through the display 170 disposed on the rear surface of the second housing part 120.

The electronic device 100 may further include a key button 139. The key button 139 may be exposed from a structure (e.g., an opening) formed on a side surface of the third housing part 130 and may be partially protruded to the outside of the electronic device 100. The key button 139 may provide a physical input to processing circuitry inside the electronic device 100 by a pressure transmitted from the outside. The key button 139 may not be included in the electronic device 100, but may be implemented in another form, such as a soft key displayed on the flexible display 140 or the display 170.

The key button 139 may be disposed on the side surface of the third housing part 130 so as to be exposed to the outside in the third state 100c. As the key button 139 is disposed on the side surface of the third housing part 130, it may be disposed in a direction in which the side surface of the third housing part 130 faces. Even when the third state 100c is changed to the first state 100a by a user looking at the display 170, a position of the key button 139 disposed on the side surface of the third housing part 130 may not be moved. For example, referring to FIG. 1A, in the first state 100a, when the flexible display 140 is viewed from above, the key button 139 may be disposed at the right. Referring to FIG. 1B, in the third state 100c, when the display 170 is viewed from above, the key button 139 may be disposed at the right.

The flexible display 140 may at least partially define an exterior of the electronic device 100. The flexible display 140 may be partially disposed in the housing structure 101. The flexible display 140 may define a front surface of the electronic device 100. The flexible display 140 may include a first unbendable portion 141, a second unbendable portion 142, a third unbendable portion 143, a first bendable portion 144, and a second bendable portion 145. The first unbendable portion 141, the second unbendable portion 142, and the third unbendable portion 143 may be included in the electronic device 100 so as not to be bent, but the first unbendable portion 141, the second unbendable portion 142, and the third unbendable portion 143, which are detached from the electronic device 100, may be deformable or bendable, like the first bendable portion 144 and the second bendable portion 145. The first unbendable portion 141 of the flexible display 140 may be disposed on the front surface of the first housing part 110. The second unbendable portion 142 of the flexible display 140 may be disposed on the front surface of the second housing part 120. The third unbendable portion 143 of the flexible display 140 may be disposed on the front surface of the third housing part 130. The first bendable portion 144 of the flexible display 140 may be disposed between the first unbendable portion 141 and the third unbendable portion 143 of the flexible display 140. For example, the first bendable portion 144 of the flexible display 140 may be disposed on the first hinge structure 150 connecting the first housing part 110 and the second housing part 120. The second bendable portion 145 of the flexible display 140 may be disposed between the second unbendable portion 142 and the third unbendable portion 143 of the flexible display 140. For example, the second bendable portion 145 of the flexible display 140 may be disposed on the second hinge structure 160 connecting the second housing part 120 and the third housing part 130.

The first hinge structure 150 and the second hinge structure 160 may face substantially the same direction as the first unbendable portion 141 of the flexible display 140, the second unbendable portion 142 of the flexible display 140, and the third unbendable portion 143 of the flexible display 140. In the first state 100a, the first bendable portion 144 and the second bendable portion 145 may be disposed in substantially the same horizontal plane as the first unbendable portion 141, the second unbendable portion 142, and the third unbendable portion 143.

The first hinge structure 150 and the second hinge structure 160 may provide the second state 100b of the electronic device 100. In the second state 100b, the first unbendable portion 141 of the flexible display 140 may face the second unbendable portion 142 of the flexible display 140, and the third unbendable portion 143 of the flexible display 140 may face the same direction as the second unbendable portion 142 of the flexible display 140. For example, the second unbendable portion 142 and the third unbendable portion 143 may be disposed in substantially the same horizontal plane.

In the second state 100b, as the first bendable portion 144 of the flexible display 140 is bent by the first hinge structure 150, the first bendable portion 144 of the flexible display 140 may be folded so that the first unbendable portion 141 of the flexible display 140 and the second unbendable portion 142 of the flexible display 140 face different directions.

In the second state 100b, as the second bendable portion 145 of the flexible display 140 is maintained in the unfolded state by the second hinge structure 160, the second bendable portion 145 of the flexible display 140 may be unfolded so that the second unbendable portion 142 of the flexible display 140 and the third unbendable portion 143 of the flexible display 140 face the same direction.

The first hinge structure 150 and the second hinge structure 160 may provide the third state 100c of the electronic device 100. In the third state 100c, the second unbendable portion 142 of the flexible display 140 may face the first unbendable portion 141 of the flexible display 140, and the third unbendable portion 143 of the flexible display 140 may face the rear surface of the first housing part 110.

In the third state 100c, as the first bendable portion 144 of the flexible display 140 is bent by the first hinge structure 150, the first bendable portion 144 of the flexible display 140 may be folded so the first unbendable portion 141 of the flexible display 140 and the second unbendable portion 142 of the flexible display 140 face different directions.

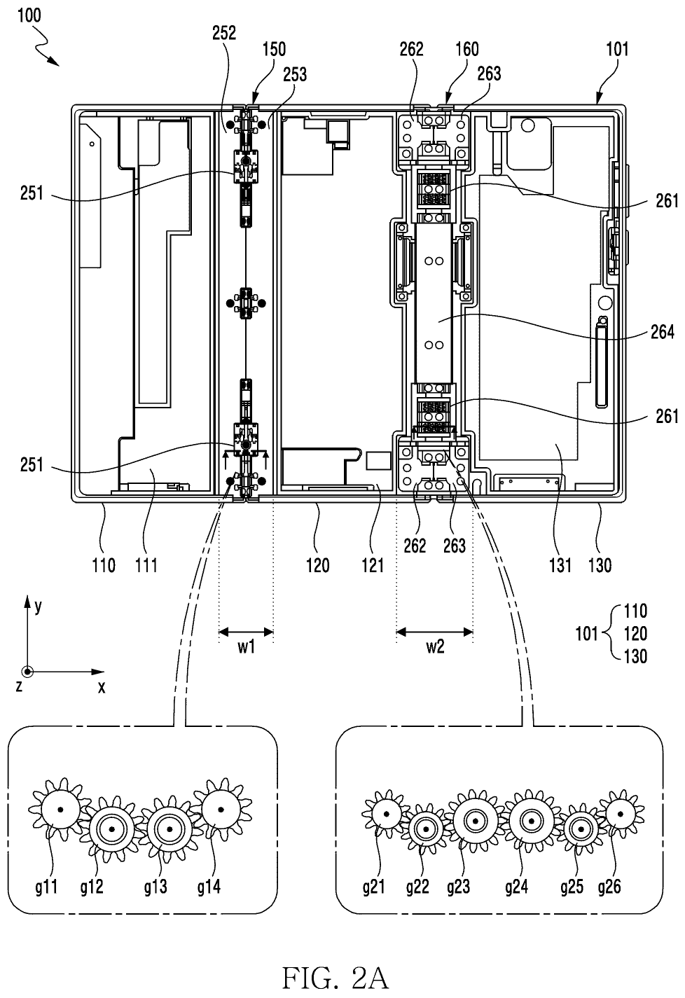

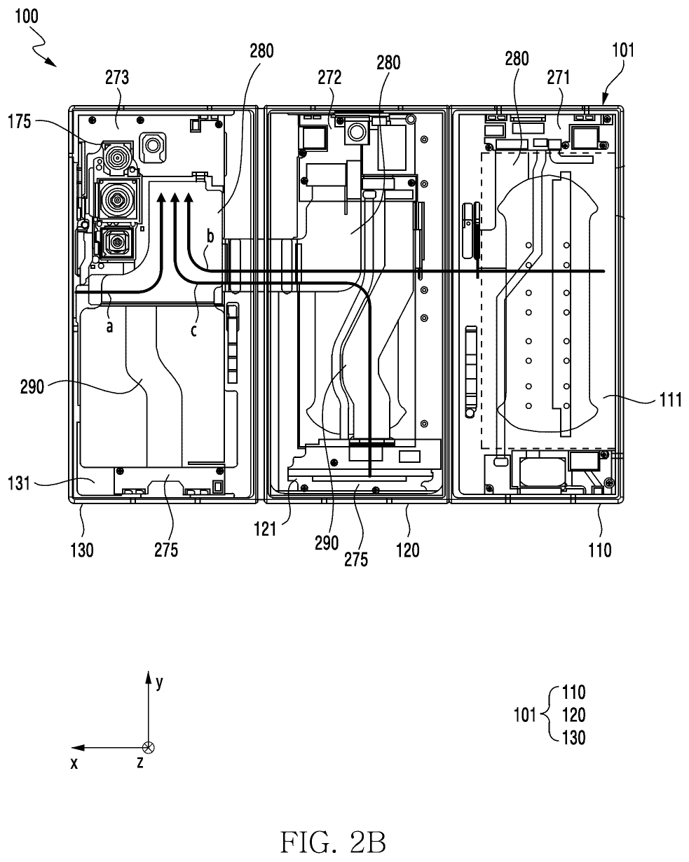

In the third state 100c, as the second bendable portion 145 of the flexible display 140 is bent by the second hinge structure 160, the second bendable portion 145 of the flexible display 140 may be folded so that the second unbendable portion 142 of the flexible display 140 and the third unbendable portion 143 of the flexible display 140 face different directions. The second bendable portion 145 may further include a first deformable portion 145a, a second deformable portion 145b, and a planar portion 145c. The first deformable portion 145a may be disposed between the planar portion 145c and the second unbendable portion 142, and the second deformable portion 145b may be disposed between the planar portion 145c and the third unbendable portion 143. The planar portion 145c may be disposed between the first deformable portion 145a and the second deformable portion 145b. The planar portion 145c may be supported by a support plate (e.g., the support plate 264 of FIG. 2A) that is distinct from hinge plates (e.g., the third hinge plate 262 and the fourth hinge plate 263 of FIG. 2A) of the second hinge structure 160. Regardless of the state of the electronic device 100, the planar portion 145c may maintain a flat surface. In the first state 100a and the second state 100b, the first deformable portion 145a and the second deformable portion 145b may be unfolded, and in the third state 100c, the first deformable portion 145a and the second deformable portion 145b may be bent so that the second unbendable portion 142 and the third unbendable portion 143 face different directions. In the third state 100c, the first housing part 110 may be disposed between the second housing part 120 and the third housing part 130. In the third state 100c, the second bendable portion 145 of the flexible display 140, which is disposed on the second hinge structure 160, may partially face a side surface 110c of the first housing part 110.

The display region of the flexible display 140 may include a first display region 140a, a second display region 140b, and a third display region 140c. The display region indicates a region capable of providing visual information from the flexible display 140. In the first state 100a, the entire display region of the flexible display 140 may be visible from the front of the housing structure 101. For example, in the first state 100a, the first display region 140a, the second display region 140b, and the third display region 140c of the flexible display 140 may be visually exposed. The electronic device 100 may provide, to the user, a large display region including the first display region 140a, the second display region 140b, and the third display region 140c.

In the second state 100b, the display region of the flexible display 140 may be partially visible from at least the front surface of the third housing part 130. For example, the third display region 140c may be visually exposed, and the first display region 140a and at least a portion of the second display region 140b may not be visually exposed.

In the third state 100c, the display regions of the flexible display 140 may not be visible. For example, in the third state 100c, the first display region 140a, the second display region 140b, and the third display region 140c of the flexible display 140 may not be visually exposed.

As a non-limiting example, when the flexible display 140 is used to display a screen in the first state 100a of the electronic device 100, the first display region 140a, the second display region 140b, and the third display region 140c of the flexible display 140 may be activated. As a non-limiting example, when the flexible display 140 is used to display a screen in the third state 100c, the first display region 140a, the second display region 140b, and the third display region 140c of the flexible display 140 may be deactivated. As a non-limiting example, when the flexible display 140 is used to display a screen in the second state 100b of the electronic device 100, the third display region 140c may be activated, and the first display region 140a and the second display region 140b of the flexible display 140 may be deactivated.

As a non-limiting example, when the flexible display 140 is used to display a screen in the first state 100a of the electronic device 100, the first display region 140a, the second display region 140b, and the third display region 140c of the flexible display 140 may display visual information. As a non-limiting example, in the third state 100c, the first display region 140a, the second display region 140b, and the third display region 140c of the flexible display 140 may provide a black image. As a non-limiting example, in the second state 100b of the electronic device 100, when the flexible display 140 is used to display a screen, the third display region 140c may provide visual information, and the first display region 140a and the second display region 140b of the flexible display 140 may provide a black image.

FIG. 2A is a plan view of an electronic device from which a flexible display is removed. FIG. 2B is a rear view of an electronic device from which a rear cover and a display are removed.

Referring to FIGS. 2A and 2B, an electronic device 100 may include a first hinge structure 150 and a second hinge structure 160. A first width w1 of the first hinge structure 150 may be narrower than a second width w2 of the second hinge structure 160. A difference between the first width w1 of the first hinge structure 150 and the second width w2 of the second hinge structure 160 may be greater than or equal to a thickness of the first housing part 110. For example, the second hinge structure 160 may have the second width w2 wider than the first width w1, so that the first housing part 110 is disposed between the second housing part 120 and the third housing part 130 according to the third state 100c. The first hinge structure 150 may be referred to as a narrow hinge structure in terms of having a narrower width than the second hinge structure 160. The second hinge structure 160 may be referred to as a wide hinge structure in terms of having a wider width than the first hinge structure 150.

The first hinge structure 150 may include a first set of gears 251, a first hinge plate 252, and a second hinge plate 253. The first hinge plate 252 may be coupled to a first support portion 111 of the first housing part 110. The second hinge plate 253 may be coupled to a second support portion 121 of the second housing part 120. Gears g11, g12, g13, and g14 included in the first set of gears 251 may be configured to rotate the first hinge plate 252 and the second hinge plate 253. For example, the gears g11, g12, g13, and g14 included in the first set of gears 251 may rotate the second hinge plate 253 (or the second housing part 120) by linking with a rotation of the first hinge plate 252 (or the first housing part 110). After the first hinge plate 252 (or the first housing part 110) is rotated, the gears g11, g12, g13, and g14 included in the first set of gears 251 may rotate in accordance with the rotation of the first hinge plate 252 (or the first housing part 110). The second hinge plate 253 (or the second housing part 120) may be rotated by linking with the rotation of the first hinge plate 252 in accordance with the rotation of the gears included in the first set of gears 251. The gears g11, g12, g13, and g14 included in the first set of gears 251 may include a first gear g11, a second gear g12, a third gear g13, and a fourth gear g14. The first gear g11 may be disposed adjacent to the first hinge plate 252, and the fourth gear g14 may be disposed adjacent to the second hinge plate 253. The second gear g12 and the third gear g13 may be disposed between the first gear g11 and the fourth gear g14. The first gear g11, the second gear g12, the third gear g13, and the fourth gear g14 may be sequentially engaged. According to a rotation of the first gear g11 in a first rotation direction (e.g., clockwise), the second gear g12 engaged with the first gear g11 may be rotated in a second rotation direction (e.g., counterclockwise) opposite to the first rotation direction. According to the rotation of the second gear g12 in the second rotation direction, the third gear g13 engaged with the second gear g12 may be rotated in the first rotation direction. According to the rotation of the third gear g13 in the first rotation direction, the fourth gear g14 may be rotated in the second rotation direction. As the first gear g11 and the fourth gear g14 rotate in different directions, the first housing part 110 connected to the first hinge plate 252 and the second housing part 120 connected to the second hinge plate 253 may be folded or unfolded.

The second hinge structure 160 may include a second set of gears 261, a third hinge plate 262, a fourth hinge plate 263, and a support plate 264. The third hinge plate 262 may be coupled to the second support portion 121 of the second housing part 120. The fourth hinge plate 263 may be coupled to a third support portion 131 of the third housing part 130. Gears g21, g22, g23, g24, g25, and g26 included in the second set of gears 261 may be configured to rotate the third hinge plate 262 and the fourth hinge plate 263. For example, the gears g21, g22, g23, g24, g25, and g26 included in the second set of gears 261 may rotate the fourth hinge plate 263 (or the third housing part 130) by linking with a rotation of the third hinge plate 262 (or the second housing part 120). After the third hinge plate 262 (or the second housing part 120) is rotated, the gears g21, g22, g23, g24, g25, and g26 included in the second set of gears 261 may rotate in accordance with the rotation of the third hinge plate 262 (or the second housing part 120). The fourth hinge plate 263 (or the third housing part 130) may be rotated by linking with the rotation of the third hinge plate 262 in accordance with the rotation of the gears g21, g22, g23, g24, g25, and g26 included in the second set of gears 261.

The gears g21, g22, g23, g24, g25, and g26 included in the second set of gears 261 may include a first gear g21, a second gear g22, a third gear g23, a fourth gear g24, a fifth gear g25, and a sixth gear g26. The first gear g21 may be disposed adjacent to the third hinge plate 262, and the sixth gear g26 may be disposed adjacent to the fourth hinge plate 263. The second gear g22, the third gear g23, the fourth gear g24, and the fifth gear g25 may be disposed between the first gear g21 and the sixth gear g26. The first gear g21, the second gear g22, the third gear g23, the fourth gear g24, the fifth gear g25, and the sixth gear g26 may be sequentially engaged. According to the rotation of the first gear g21 in a first rotation direction (e.g., clockwise), the second gear g22 engaged with the first gear g21 may be rotated in a second rotation direction (e.g., counterclockwise) opposite to the first rotation direction. According to the rotation of the second gear g22 in the second rotation direction, the third gear g23 engaged with the second gear g22 may be rotated in the first rotation direction. According to the rotation of the third gear g23 in the first rotation direction, the fourth gear g24 may be rotated in the second rotation direction. According to the rotation of the fourth gear g24 in the second rotation direction, the fifth gear g25 engaged with the fourth gear g24 may be rotated in the first rotation direction. According to the rotation of the fifth gear g25 in the first rotation direction, the sixth gear g26 engaged with the fifth gear g25 may be rotated in the second rotation direction. As the first gear g21 and the sixth gear g26 rotate in different directions, the second housing part 120 connected to the third hinge plate 262 and the third housing part 130 connected to the fourth hinge plate 263 may be folded or unfolded.

The first hinge structure 150 and the second hinge structure 160 may further include a spiral structure. The spiral structure may include a spiral groove formed in each hinge plate or rotation member connected to the hinge plate, and a moving member sliding along the spiral groove. The hinge plates connected to the hinge structure may be configured to rotate with substantially the same angular displacement through the spiral structure.

The electronic device 100 may include a first printed circuit board 271, a second printed circuit board 272, and a third printed circuit board 273.

The first printed circuit board 271 may be disposed in the first support portion 111 of the first housing part 110. A hardware component in the first housing part 110 may be disposed on the first printed circuit board 271. The second printed circuit board 272 may be disposed in the second support portion 121 of the second housing part 120. The third printed circuit board 273 may be disposed in the third support portion 131 of the third housing part 130. A hardware component in the third housing part 130 may be disposed on the third printed circuit board 273.

A hardware component disposed on the first printed circuit board 271 may support a hardware component disposed on the second printed circuit board 272 and/or a hardware component disposed on the third printed circuit board 273 or may operate independently.

The hardware component disposed on the second printed circuit board 272 may support the hardware component disposed on the first printed circuit board 271 or the third printed circuit board 273, or may operate independently. The hardware component disposed on the second printed circuit board 272 may include a speaker, a front camera, and/or display driving circuitry.

The hardware component disposed on the third printed circuit board 273 may include at least one processor (e.g., an application processor (AP), a communication processor (CP)) including processing circuitry, memory including one or more storage media, communication circuitry, and a rear camera 175. The rear camera 175 may be exposed through a structure (e.g., an opening) on the rear surface of the second housing part 120.

The electronic device 100 may further include a sub-printed circuit board 275, flexible printed circuit boards 280 and 290. The sub-printed circuit board 275 may be disposed on at least a portion of the first housing part 110, the second housing part 120, and the third housing part 130. The flexible printed circuit board 280 and 290 may include a first flexible printed circuit board 280 and a second flexible printed circuit board 290. The first flexible printed circuit board 280 may electrically connect printed circuit boards disposed in each of housing parts 110, 120, and 130. The second flexible printed circuit board 290 may connect the sub-printed circuit board 275 and a printed circuit board within a housing part in which the sub-printed circuit board 275 is disposed, by the second flexible printed circuit board 290.

Components within the electronic device 100 may be connected to at least one processor within the third printed circuit board 273 through the flexible printed circuit boards 280 and 290. For example, a signal received from an antenna disposed in the third housing part 130 may be transmitted, through a signal path (a) provided by the first flexible printed circuit board 280, to the third printed circuit board 273 on which at least one processor (e.g., AP or CP) is disposed. Driving circuitry for the flexible display 140 disposed within the first housing part 110 may be electrically connected to the third printed circuit board 273 on which at least one processor (e.g., AP) is disposed, through a signal path (b) provided by the sub-printed circuit board 275 and the first flexible printed circuit board 280. Driving circuitry for the display 170 connected to the sub-printed circuit board 275 disposed in the second housing part 120 may be electrically connected to the third printed circuit board 273 on which at least one processor (e.g., AP) is disposed, through a signal path (c) provided by the sub-printed circuit board 275 and the first flexible printed circuit board 280 and the second flexible printed circuit board 290.

The electronic device 100 may further include batteries. Each of the batteries may be attached to support portions 111, 121, and 131 included in the housing parts 110, 120, and 130. The support portions 111, 121, and 131 may support rechargeable batteries.

The arrangement of hardware components is exemplary, unlike the above description, the rear camera 175 and the second printed circuit board 272 may be disposed in the third housing part 130, and the third printed circuit board 273 may be disposed in the second housing part 120.

It is illustrated that the first housing part 110 and the third housing part 130 rotate in the opposite direction with respect to the second housing part 120, but are not limited thereto. For example, while changing from the first state 100a to the third state 100c, the first housing part 110 may rotate counterclockwise with respect to the second housing part 120, and the third housing part 130 may rotate counterclockwise with respect to the second housing part 120. As the first housing part 110 and the third housing part 130 rotate in the same direction, a portion of the display region of the flexible display 140 within the second state may be visually exposed.

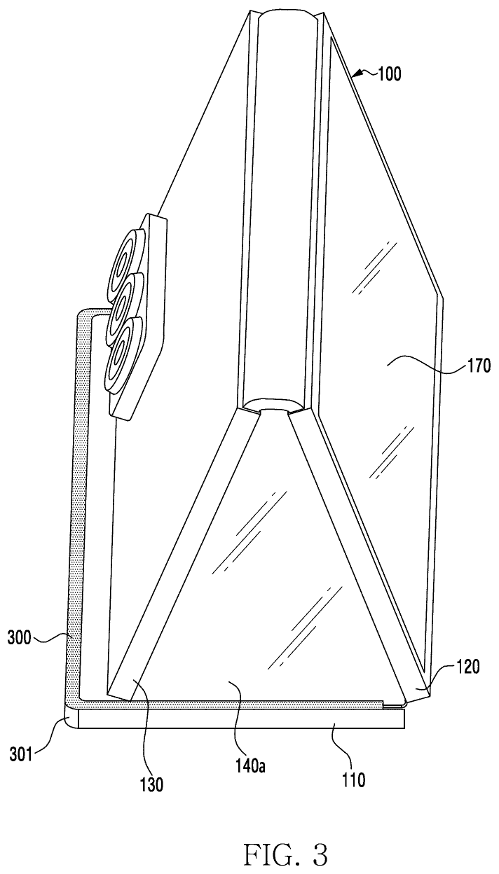

The housing structure 101 of the electronic device 100 (which may be described as the housing 101) may include a first housing part 110, a second housing part 120 rotatably coupled with respect to the first housing part 110, and a third housing part 130 rotatably coupled with respect to the second housing part 120. Since the second housing part 120 is rotatably coupled with respect to both the first housing part 110 and the third housing part 130, the second housing part 120 may be partially folded with respect to both the first housing part 110 and the third housing part 130. The electronic device 100 may be configured to have a triangular prism shape, in accordance with the second housing part 120 being partially folded with respect to both the first housing part 110 and the third housing part 130. The electronic device 100 having the triangular prism shape is described with reference to FIG. 3.

FIG. 3 illustrates an electronic device having a triangular prism shape.

Referring to FIG. 3, the second housing part 120 may be partially folded with respect to the first housing part 110 and partially folded with respect to the third housing part 130. The third housing part 130 may be supported by the first housing part 110, in accordance with the second housing part 120 being partially folded with respect to the first housing part 110 and the third housing part 130. A portion of the third housing part 130 may be positioned on the first housing part 110 (or the first display region 140a), in accordance with the second housing part 120 being partially folded with respect to the first housing part 110 and the third housing part 130. The electronic device 100 may be configured to have a triangular prism shape (or rounded triangular prism shape) when the third housing part 130 is supported by the first housing part 110 in accordance with the second housing part 120 being partially folded with respect to the first housing part 110 and the third housing part 130, as illustrated in FIG. 3. The electronic device 100 may be configured to have the triangular prism shape when a portion of the third housing part 130 is positioned (or contacted) on the first housing part 110 (or the first display region 140a). The electronic device 100 may be configured to have the triangular prism shape when the third housing part 130 is supported by the first display region 140a disposed above the first housing part 110. The electronic device 100 may be configured to have the triangular prism shape when the third housing part 130 is supported by a front frame 300 of the first housing part 110. The front frame 300 may be described as a component of the first housing part 110 that is supported by a side wall 301 of the first housing part 110 and covers a portion of a periphery of the foldable display 140. The front frame 300 may include a plurality of portions. The plurality of portions of the front frame 300 will be described below.

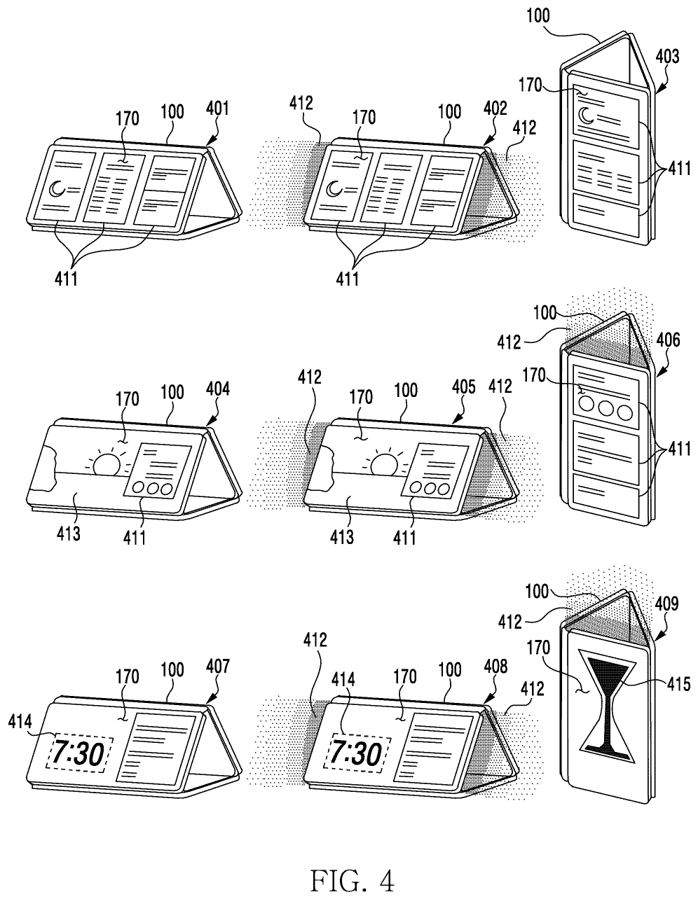

When the electronic device 100 has the triangular prism shape, the electronic device 100 may provide various user experiences (UXs). For example, the electronic device 100 having the triangular prism shape may provide various user experiences through the foldable display 140 forming inner side surfaces of the triangular prism. For example, the electronic device 100 having the triangular prism shape may provide various user experiences through the display 170 disposed above (or on) a rear wall of the second housing part 120. The display170 may also be disposed above (or on) a rear wall of the third housing part 130, according to an embodiment. A function for providing the various user experiences is described with reference to FIG. 4.

FIG. 4 illustrates a function executed by an electronic device having a triangular prism shape.

Referring to FIG. 4, the electronic device 100 having a triangular prism shape may display one or more widgets 411 through the display 170, as in a state 401. As a non-limiting example, the one or more widgets 411 may be provided within a locked state of the electronic device 100 in which some of functions of the electronic device 100 are inaccessible. The state 401 may be described as a state that displays information (e.g., the one or more widgets 411) while the first housing part 110 or the third housing part 130 of the housing 101 of the electronic device 100 having the triangular prism shape is supported by an external object (e.g., the ground or a desk). As a non-limiting example, in the state 401, the foldable display 140 may be disabled (or deactivated, or turned off). For example, in the state 401, the foldable display 140 may provide a black color.

The electronic device 100 having the triangular prism shape may emit light 412 through the foldable display 140, while displaying the one or more widgets 411 through the display 170), as in a state 402. The state 402 may be described as a state that further emits the light 412 through the foldable display 140 relative to the state 401. In the state 402, the light 412 may be emitted to (intuitively) indicate a state of a user and/or a state of the electronic device 100. For example, the light 412 may be emitted to indicate information (e.g., weather information) provided through at least a portion of the one or more widgets 411. In the state 402, the light 412 may also be emitted for aesthetic purposes.

The electronic device 100 having the triangular prism shape may display the one or more widgets 411 through the display 170, as in a state 403. The state 403 may be described as a state that displays information (e.g., the one or more widgets 411) while the side wall of the first housing part 110, the side wall of the second housing part 120, and the side wall of the third housing part 130, which define a bottom side of the triangular prism, are supported by an external object. As a non-limiting example, in the state 403, the foldable display 140 may be deactivated, as in the state 401.

The electronic device 100 having the triangular prism shape may display a background image 413 and the one or more widgets 411 superimposed on the background image 413 through the display 170, as in a state 404. The state 404 may be described as a state that further displays the background image 413 relative to the state 401. For example, the background image 413 may be displayed to induce a user's action. As a non-limiting example, the background image 413 may be displayed for the user's sleep. As a non-limiting example, in the state 404, the foldable display 140 may be deactivated, as in the state 401.

The electronic device 100 having the triangular prism shape may emit light 412 through the foldable display 140, while displaying the background image 413 and the one or more widgets 411 superimposed on the background image 413 through the display 170, as in a state 405. The state 405 may be described as a state that further emits the light 412 through the foldable display 140 relative to the state 404. In the state 405, the light 412 may represent information provided through the background image 413, and/or may represent information provided through at least a portion of the one or more widgets 411. In the state 405, the light 412 may be emitted for aesthetic purposes.

The electronic device 100 having the triangular prism shape may emit light 412 through the foldable display 140, while displaying the one or more widgets 411 through a display 170, as in a state 406. The state 406 may be described as a state that further emits light 412 through the foldable display 140 relative to the state 403.

The electronic device 100 having the triangular prism shape may simultaneously display the one or more widgets 411 and a clock 414, through the display as in a state 407. The clock 414 may indicate a local time of a geographical location where the electronic device 100 is located. The state 407 may be described as a state that further displays the clock 414 relative to the state 401. As a non-limiting example, in the state 407, the foldable display 140 can be deactivated, as in the state 401.

The electronic device 100 having the triangular prism shape may emit light 412 while simultaneously displaying the one or more widgets 411 and the clock 414 through the display 170, as in a state 408. The state 408 may be described as a state that further emits light 412 through the foldable display 140 relative to the state 407. As a non-limiting example, the light 412 may be emitted to indicate the time indicated by the clock 414.

The electronic device 100 having the triangular prism shape may display an clock 414(e.g., sandglass (414) through the display 170, as in a state 409. The state 409 may be described as a state that displays information (e.g., the clock 414) while the side wall of the first housing part 110, the side wall of the second housing part 120, and the side wall of the third housing part 130, which define the bottom side of the triangular prism, are supported by an external object. As a non-limiting example, the clock 414 may be a function of the electronic device 100 displayed in the state 409. In the state 409, the electronic device 100 may further emit the light 412 through the foldable display 140.

The electronic device 100 having the triangular prism shape may be configured to further perform second functions as well as the first functions exemplified through the states 401 to 409. The first functions and the second functions may be performed based on a prism mode of the electronic device 100. The prism mode of the electronic device 100 may be described as a mode provided while identifying the electronic device 100 having the triangular prism shape through one or more sensors of the electronic device 100.

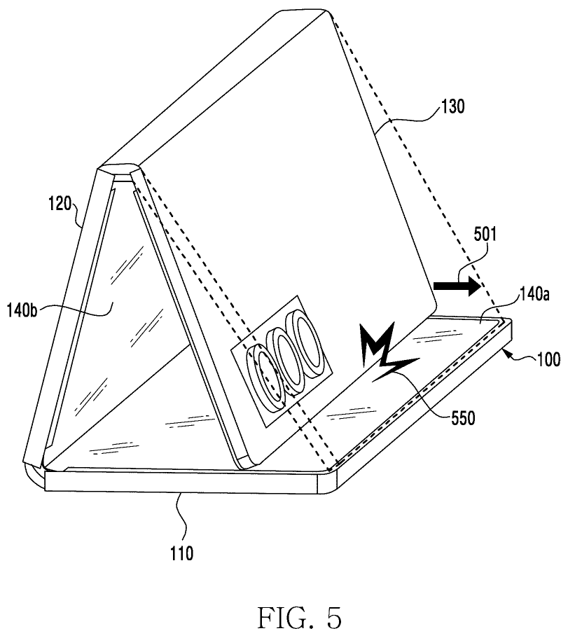

While the electronic device 100 has the triangular prism shape to provide various user experiences, the third housing part 130 may be supported by the foldable display 140 and/or the first housing part 110. When an unintended impact is applied (or provided) to the electronic device 100 having the triangular prism shape, the third housing part 130 may damage the foldable display 140. The impact is described with reference to FIG. 5.

FIG. 5 illustrates an impact that may occur in relation to a display of an electronic device having a triangular prism shape.

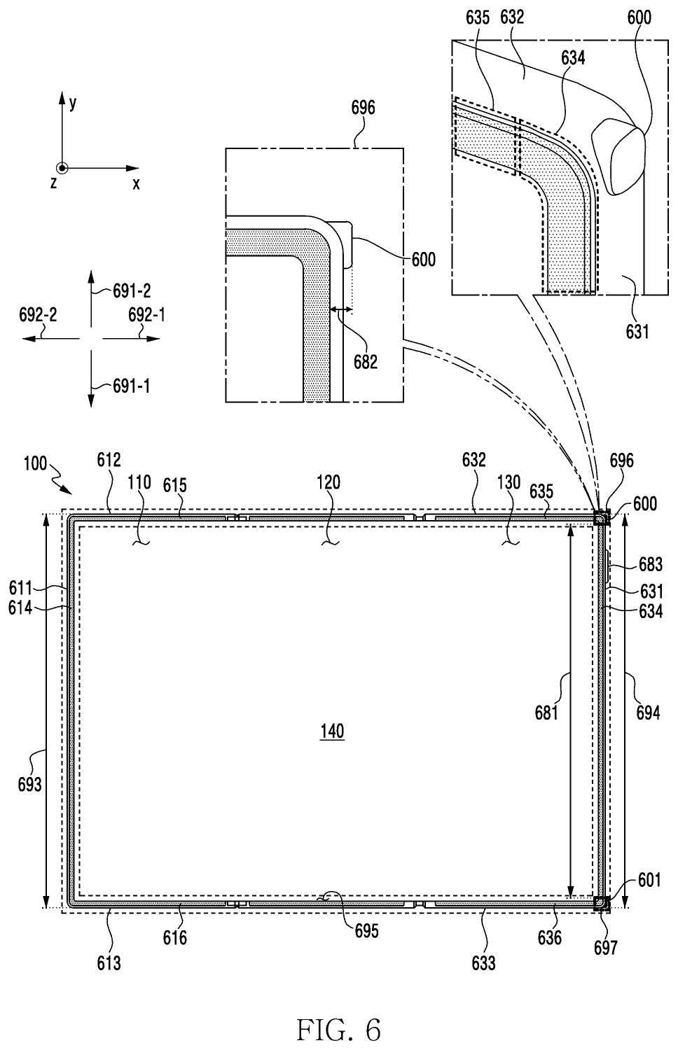

Referring to FIG. 5, the electronic device 100 may have a triangular prism shape according to the second housing part 120 being partially folded with respect to the first housing part 110 and the third housing part 130. In the electronic device 100 described with reference to FIG. 5, the structure described through FIGS. 6 to 23 may be omitted.

While the electronic device 100 has the triangular prism shape, a portion of the third housing part 130 may be contacted on the first display region 140a of the foldable display 140, which is disposed above the first housing part 110. Since the portion of the third housing part 130 is contacted on the first display region 140a of the foldable display 140 disposed above the first housing part 110 while the electronic device 100 has the triangular prism shape, the third housing part 130 may be supported by the foldable display 140 while the electronic device 100 has the triangular prism shape.

For example, the electronic device 100 having the triangular prism shape may be dropped contrary to user intention. The first housing part 110 (or the rear wall of the first housing part 110) of the dropped electronic device 100 may collide with an external object (e.g., the ground). Since the foldable display 140 supports the third housing part 130 while the electronic device 100 has the triangular prism shape, an impact 550 transmitted from the third housing part 130 to at least a portion (e.g., the first display region 140a) of the foldable display 140 may occur due to the collision with the external object. The impact 550 may damage at least a portion of the foldable display 140. For example, a window of the foldable display 140 may be at least partially broken by the impact 550. For example, at least a portion of pixels in the foldable display 140 may be damaged by the impact 550. The electronic device 100 having the triangular prism shape may provide various user experiences, but the foldable display 140 of the electronic device 100 having the triangular prism shape may be damaged due to the impact 550. A structure for reducing the damage of the foldable display 140 due to the impact 550 will be described with reference to FIGS. 6 to 23.

At least a portion of the side wall of the third housing part 130 may be formed from a relatively slippery material (e.g., metal). A window of the foldable display 140, which is an outer surface of the foldable display 140, may be formed from a relatively slippery material (e.g., glass). Since at least a portion of the side wall of the third housing part 130 and the window of the foldable display 140 are formed from a relatively slippery material, the third housing part 130 may slide in a direction indicated by an arrow 501 on the foldable display 140 (or the first display region 140a) while the electronic device 100 has the triangular prism shape. Since the third housing part 130 sliding on the foldable display 140 may be different from user intention, a structure for maintaining a posture (or position) of the third housing part 130 contacted on the foldable display 140 will be described with reference to FIGS. 6 to 17.

FIG. 6 illustrates a damper included in a third housing part of an electronic device.

Referring to FIG. 6, the electronic device 100 may further include a damper 600 in relation to the electronic device 100 illustrated in FIG. 5.

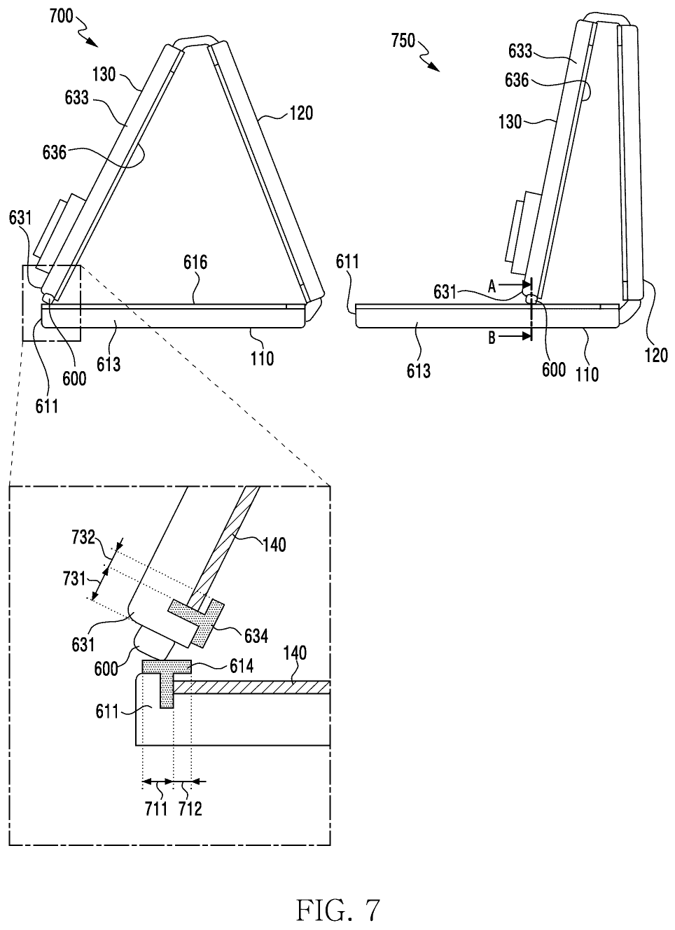

The first housing part 110 may include a side wall 611 defining a portion 693 of a periphery 695 of the electronic device 100. The side wall 611 may extend from a rear wall (or bottom wall) of the first housing part 110. The side wall 611 may have a longitudinal direction corresponding to a direction 691-1 or a direction 691-2. The side wall 611 will be illustrated in more detail in FIG. 7.

The side wall 611 may include conductive portions, and one or more non-conductive portions between the conductive portions. Each of the conductive portions may function as an antenna radiator. Each of the conductive portions may be formed from a metal. For example, each of the conductive portions may be formed from stainless steel, titanium, and/or aluminum. For example, the one or more non-conductive portions may be formed from a plastic.

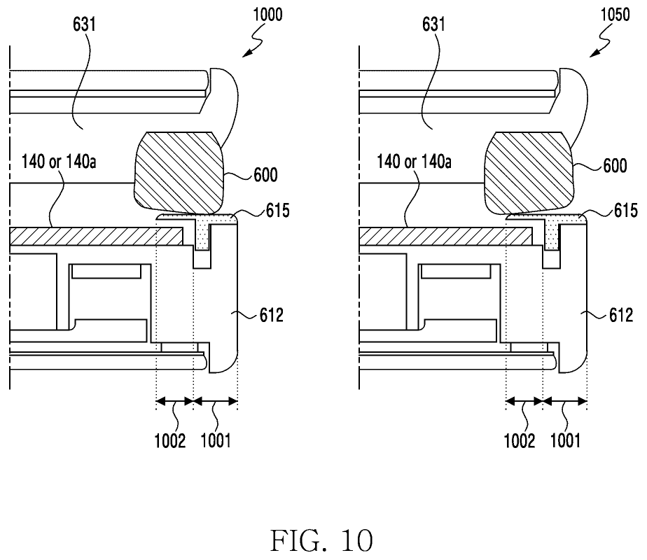

The first housing part 110 may include a side wall 612 defining a portion of the periphery 695 of the electronic device 100 and a side wall 613 defining a portion of the periphery 695 of the electronic device 100. The side wall 612 and the side wall 613 may extend from the rear wall of the first housing part 110. Each of the side wall 612 and the side wall 613 may have a longitudinal direction corresponding to a direction 692-1 or a direction 692-2. Each of the side wall 612 and the side wall 613 may extend from the side wall 611 in the direction 692-1. The side wall 612 will be illustrated in more detail in FIG. 10.

The first housing part 110 may include a front frame portion 614 that is supported by the side wall 611 of the first housing part 110 and covers a portion of a periphery (or edge) of the foldable display 140. The front frame portion 614 may be described as a protection member. The front frame portion 614 may correspond to the front frame 300 of the first housing part 110 described with reference to FIG. 3. The front frame portion 614 may have a longitudinal direction corresponding to the direction 691-1 or the direction 691-2. The front frame portion 614 will be described in more detail in FIG. 7. The front frame portion 614 may be contacted to the portion of the periphery of the foldable display 140.

The first housing part 110 may include a front frame portion 615 that is supported by the side wall 612 of the first housing part 110 and covers a portion of a periphery of the foldable display 140. The front frame portion 615 may be described as a protection member. The front frame portion 615 may have a longitudinal direction corresponding to the direction 692-1 or the direction 692-2. The front frame portion 615 may extend from the front frame portion 614 in the direction 692-1. The front frame portion 615 will be illustrated in more detail in FIG. 10. The front frame portion 615 may be contacted to the portion of the periphery of the foldable display 140.

The first housing part 110 may include a front frame portion 616 that is supported by the side wall 613 of the first housing part 110 and covers a portion of a periphery of a foldable display 140. The front frame portion 616 may be described as a protection member. The front frame portion 616 may have a longitudinal direction corresponding to the direction 692-1 or the direction 692-2. The front frame portion 616 may extend from the front frame portion 614 in the direction 692-1. The front frame portion 616 may be contacted to the portion of the periphery of the foldable display 140.

The third housing part 130 may include a side wall 631 defining a portion 694 of the periphery 695 of the electronic device 100. The side wall 631 may extend from a rear wall (or bottom wall) of the third housing part 130. The side wall 631 may have a longitudinal direction corresponding to the direction 691-1 or the direction 691-2. The side wall 631 will be illustrated in more detail in FIG. 7.

The side wall 631 may include conductive portions, and one or more non-conductive portions between the conductive portions. Each of the conductive portions may function as an antenna radiator. Each of the conductive portions may be formed from a metal. For example, each of the conductive portions may be formed from stainless steel, titanium, and/or aluminum. For example, the one or more non-conductive portions may be formed from a plastic.

The third housing part 130 may include a side wall 632 defining a portion of the periphery 695 of the electronic device 100 and a side wall 633 defining a portion of the periphery 695 of the electronic device 100. The side wall 632 and the side wall 633 may extend from the rear wall of the third housing part 130. Each of the side wall 632 and the side wall 633 may have a longitudinal direction corresponding to the direction 692-1 or the direction 692-2. Each of the side wall 632 and the side wall 633 may extend from the side wall 631 in the direction 692-2. The side wall 632 will be illustrated in more detail in FIG. 10.

The third housing part 130 may include a front frame portion 634 that is supported by the side wall 631 of the third housing part 130 and covers a portion of a periphery of the foldable display 140. The front frame portion 634 may be described as a protection member. The front frame portion 634 may have a longitudinal direction corresponding to the direction 691-1 or the direction 691-2. The front frame portion 634 will be illustrated in more detail in FIG. 7. The front frame portion 634 may be contacted to the portion of the periphery of the foldable display 140.

The third housing part 130 may include a front frame portion 635 that is supported by the side wall 632 of the third housing part 130 and covers a portion of the periphery of the foldable display 140. The front frame portion 635 may be described as a protection member. The front frame portion 635 may have a longitudinal direction corresponding to the direction 692-1 or the direction 692-2. The front frame portion 635 may extend from the front frame portion 634 in the direction 692-2. The front frame portion 635 will be illustrated in more detail in FIG. 10. The front frame portion 635 may be contacted to the portion of the periphery of the foldable display 140.

The third housing part 130 may include a front frame portion 636 that is supported by the side wall 633 of the third housing part 130 and covers a portion of the periphery of the foldable display 140. The front frame portion 636 may be described as a protection member. The front frame portion 636 may have a longitudinal direction corresponding to the direction 692-1 or the direction 692-2. The front frame portion 636 may extend from the front frame portion 634 in the direction 692-2. The front frame portion 636 may be contacted to the portion of the periphery of the foldable display 140.

The third housing part 130 may include a damper 600 and a damper 601. The damper 600 may be described as a first buffer member, and the damper 601 may be described as a second buffer member. The first buffer member and/or the second buffer member may be described as buffer members. The damper 600 and the damper 601 may be configured to protrude from a portion of the side wall 631 of the third housing part 130 (or in a direction of the side wall 631). The damper 600 may be disposed at a first position of the side wall 631 of the third housing part 130, and the damper 601 may be disposed at a second position of the side wall 631 of the third housing part 130. The damper 600 and the damper 601 may be structures included in the electronic device 100 to reduce the damage due to the impact 550 described with reference to FIG. 5. The damper 600 and the damper 601 may be structures included in the electronic device 100 to maintain a posture (or position) of the third housing part 130 contacted on the foldable display 140. The damper 600 and the damper 601 may be formed from a material for absorbing the impact 550. For example, the damper 600 and the damper 601 may be formed from rubber. For example, the damper 600 and the damper 601 may be formed from urethane. For example, the damper 600 and the damper 601 may be formed from silicone. As a non-limiting example, since the damper 600 and the damper 601 are contacted to the foldable display 140 or the first housing part 110, the damper 600 and the damper 601 may be formed from a material having wear resistance (e.g., polyoxymethylene (POM) or polycarbonate (PC)). A contact area between the damper 600 formed from POM (or PC) and the first housing part 110 (or foldable display 140) may be wider than a contact area between the damper 600 formed from rubber (or urethane) (or silicone) and the first housing part 110 (or foldable display 140).

The damper 600 and damper 601 may protrude from a portion of the side wall 631 of the third housing part 130.

A size of a portion of the damper 600 protruded from the portion of the side wall 631 of the third housing part 130 is described with reference to FIG. 7.

FIG. 7 illustrates a size of a damper included in a third housing part of an electronic device.

Referring to FIG. 7, while the electronic device 100 has the triangular prism shape, the third housing part 130 may be contacted to the first housing part 110 or the foldable display 140 only through the damper 600.

The front frame portion 614 of the first housing part 110 may include a first portion 711 supported by the side wall 611 of the first housing part 110 and a second portion 712 covering a portion of the periphery of the foldable display 140. The first portion 711 of the front frame portion 614 may be disposed on the side wall 611.

The front frame portion 634 of the third housing part 130 may include a first portion 731 supported by the side wall 631 of the third housing part 130 and a second portion 732 covering a portion of the periphery of the foldable display 140. The first portion 731 of the front frame portion 634 may be disposed on the side wall 631.

Since the first portion 711 of the front frame portion 614 is disposed on the side wall 611 and the first portion 731 of the front frame portion 634 is disposed on the side wall 631, the damper 600 may be protruded from the portion of the side wall 631 so that the third housing part 130 is contacted on the front frame portion 614 only through the damper 600, within the state 700. For example, when the damper 600 is protruded from the portion of the side wall 631 so that the front frame portion 634 is spaced from the front frame portion 614 within the state 700, while the electronic device 100 has the triangular prism shape, the third housing part 130 may be contacted to the first housing part 110 or the foldable display 140 only through the damper 600. For example, when the damper 600 is protruded from the portion of the side wall 631 so that the front frame portion 634 is spaced apart from the front frame portion 614 within the state 700, the third housing part 130 may be contacted on the foldable display 140 (or the first display region 140a) or the first housing part 110 only through the damper 600 within the state 750.

In other words, when the third housing part 130 is supported by the front frame portion 614 according to the second housing part 120 partially folded with respect to the first housing part 110 and the third housing part 130, the front frame portion 634 may be spaced apart from the front frame portion 614 by the damper 600 contacted on the front frame portion 614.

Referring back to FIG. 6, the side wall 631 may include a rounded corner portion 696 and a rounded corner portion 697 of the electronic device 100. The rounded corner portion 696 of the side wall 631 may correspond to an end portion of the side wall 631 connected to the side wall 632, and the rounded corner portion 697 of the side wall 631 may correspond to another end portion of the side wall 631 connected to the side wall 633. The side wall 631 may further include a portion 681, which corresponds to a planar portion of a lateral surface of a rounded cuboid and extends from the rounded corner portion 696 to the rounded corner portion 697.

A portion of the side wall 631 from which the damper 600 is protruded may correspond to the rounded corner portion 696. A portion of the side wall 631 from which the damper 601 is protruded may correspond to the rounded corner portion 697. The damper 600 may be protruded from the rounded corner portion 696 in the direction 692-1. The damper 601 may be protruded from the rounded corner portion 697 in the direction 692-1.

The damper 600 may be protruded further than the portion 681 of the side wall 631. As a non-limiting example, a vertical height 682 of the damper 600, which is defined from the portion 681 of the side wall 631, may be greater than about 0.1 millimeter (mm).

The third housing part 130 may include a button 683 (or key button 683) (e.g., the key button 139). The damper 600 may be more protruded from the side wall 631 than the button 683. For example, while the electronic device 100 has a triangular prism shape, the damper 600 may be more protruded from the side wall 631 than the button 683, in order to reduce (or prevent) the third housing part 130 from contacting the first housing part 110 or the foldable display 140 through the button 683.

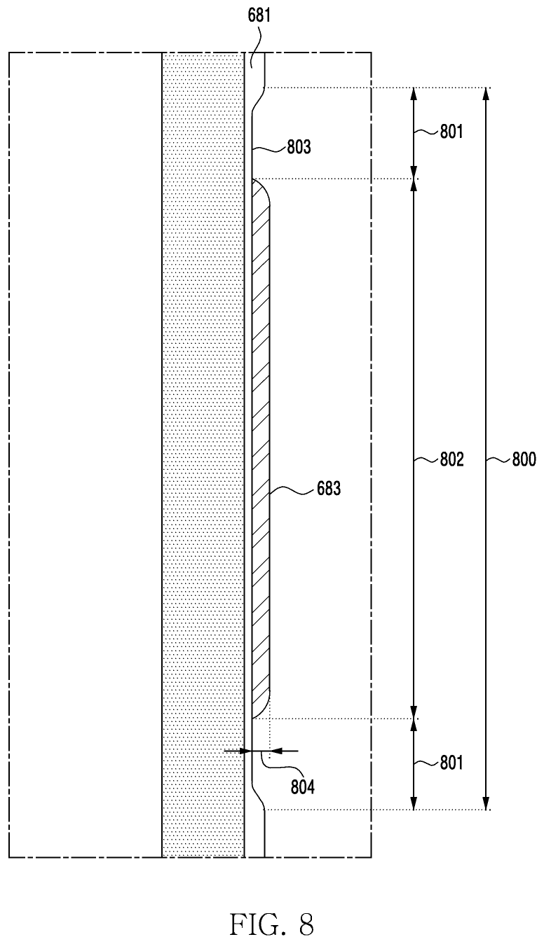

Since the button 683 is a physical button configured to receive a press input, a structure for providing a sense of distinguishing the button 683 may be applied to the side wall 631. This structure is described with reference to FIG. 8.

FIG. 8 illustrates a button included in a third housing part of an electronic device.

Referring to FIG. 8, the side wall 631 (or the portion 681 of the side wall 631) may include a dented portion 800. The button 683 included in the third housing part 130 may be protruded from the dented portion 800. The dented portion 800 may include a first portion 802 from which the button 683 is protruded, and second portions 801 surrounding the button 683. The second portions 801 of the dented portion 800 surrounding the button 683 may provide a sense of distinguishing the button 683. As a non-limiting example, a height 804 of the button 683 protruded from a base 803 of the dented portion 800 may be longer than about 0.3 (mm) and shorter than about 0.5 (mm).

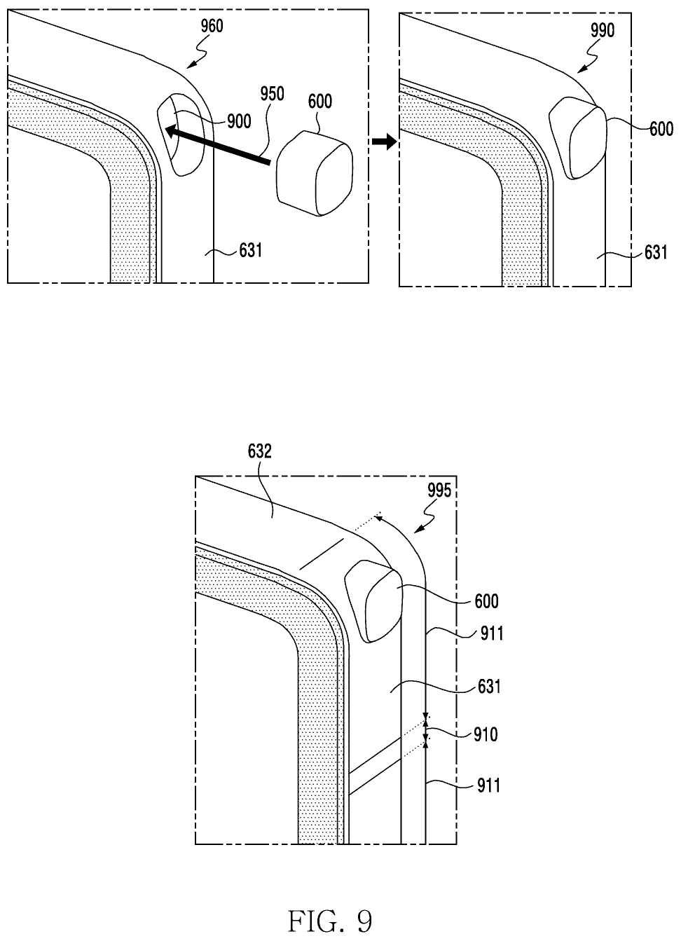

Referring back to FIG. 6, since the damper 600 is pressed (or depressed) by the first housing part 110 or the foldable display 140, the damper 600 may be attached to the side wall 631 from the outside of the electronic device 100. The damper 600 attached to the side wall 631 from the outside of the electronic device 100 is described with reference to FIG. 9.

FIG. 9 illustrates a method of including a damper in a third housing part of an electronic device.

Referring to FIG. 9, as in a state 960, the side wall 631 of the third housing part 130 may include a groove portion 900. A portion of the damper 600 may be inserted into the groove portion 900 or may be included within the groove portion 900, as indicated by the arrow 950. For example, as in a state 990, the damper 600 inserted into the groove portion 900 may be protruded from the side wall 631. For example, the damper 600 may be attached to the side wall 631 by the portion of the damper 600 that is fitted into the groove portion 900. For example, the damper 600 may be attached to the groove portion 900 via an adhesive on the portion of the damper 600. However, embodiments of the disclosure are not limited thereto. For example, the groove portion 900 may be replaced with an opening defined by the side wall 631. The damper 600 may include a first portion that passes through the opening and is protruded from the side wall 631, a second portion that is positioned within the opening and is contacted to the opening, and a flange portion that is attached to an inner surface of the side wall 631 and has a size larger than a size of the opening. The damper 600 may be attached to the side wall 631 by the flange portion of the damper 600 attached to a portion of the inner surface of an opening portion of the side wall 631 surrounding the opening.

As a non-limiting example, the side wall 631 may include conductive portions 911 and non-conductive portions 910 between the conductive portions 911, as described above. The damper 600 and the non-conductive portion 910 may be attached to the conductive portions 911 of the side wall 631 through an injection process. For example, the damper 600 and the non-conductive portion 910 attached to the conductive portions 911 may be provided, by injecting a molten resin (molten plastic) forming the damper 600 and the non-conductive portion 910 into a mold into which the conductive portions 911 are inserted, and hardening the molten resin injected into the mold.

Referring back to FIG. 6, since the damper 600 is disposed within the rounded corner portion 696 connected to the side wall 632, the damper 600 may be contacted on the front frame portion 615, while the electronic device 100 has the triangular prism shape. The front frame portion 615 may include a first portion supported by the side wall 612, and a second portion extending from the first portion of the front frame portion 615 and covering a portion of the periphery of the foldable display 140. Since the second portion of the front frame portion 615 covers a portion of the periphery of the foldable display 140, the damper 600 may have a shape to be contacted on the first portion of the front frame portion 615 while the electronic device 100 has the triangular prism shape. Since the first portion of the front frame portion 615 is supported by the side wall 612, the damper 600 may have a shape to be contacted on the first portion of the front frame portion 615 while the electronic device 100 has the triangular prism shape. The shape is described with reference to FIG. 10.

FIG. 10 illustrates a shape of a damper included in a third housing part of an electronic device.

Referring to FIG. 10, a state 1000 may correspond to the cross-sectional view of A-B in FIG. 7. The front frame portion 615 may include a first portion 1001 supported by the side wall 612 and a second portion 1002 covering a portion of the periphery of the foldable display 140.

The damper 600 being protruded from the side wall 631 of the third housing part 130 may be contacted on the first portion 1001 of the front frame portion 615, when the third housing part 130 is positioned on a portion of the foldable display 140 (e.g., a portion of the first display region 140a) positioned above the first housing part 110, according to the second housing part 120 partially folded with respect to the first housing part 110 and the third housing part 130, as in the state 1000. As a non-limiting example, force from the damper 600 protruded from the side wall 631 of the third housing part 130 may be distributed toward the side wall 612 through the first portion 1001 of the front frame portion 615 contacted on the damper 600.

The damper 600 protruded from the side wall 631 of the third housing part 130 may have a shape that prevents (or reduces) being contacted on only the second portion 1002 of the front frame portion 615, when the third housing part 130 is positioned on a portion of the foldable display 140 (e.g., a portion of the first display region 140a) positioned above the first housing part 110, according to the second housing part 120 partially folded with respect to the first housing part 110 and the third housing part 130, as in a state 1050.

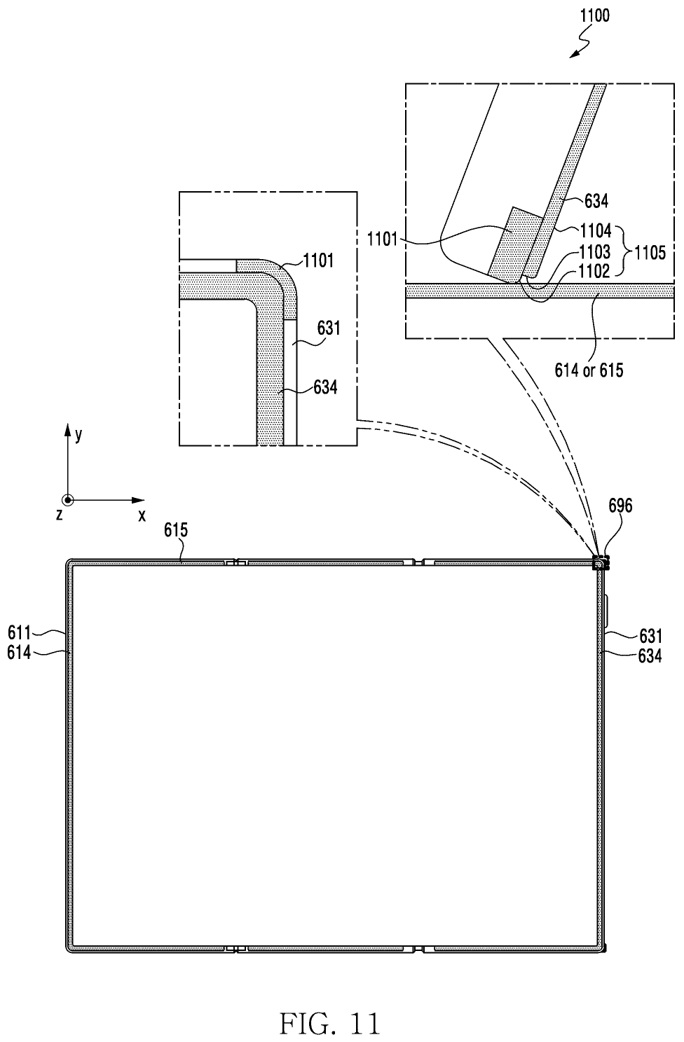

The damper 600 may be included in the electronic device 100 to reduce damage of the foldable display 140 and/or to reduce sliding of the third housing part 130 on the foldable display 140, but embodiments of the disclosure are not limited to the damper 600. For example, the damper 600 may be replaced or modified with another structure. Another structure is described with reference to FIGS. 11 to 23.

FIG. 11 illustrates a first example configuration of an expanded front frame portion in a third housing part of an electronic device.

Referring to FIG. 11, the damper 600 may be replaced with an expanded (or extended) front frame portion 1101, which is included within the third housing part 130. For example, the expanded front frame portion 1101 may be disposed within the rounded corner portion 696. The expanded front frame portion 1101 may be expanded or extended from a portion of the front frame portion 634. The expanded front frame portion 1101 may be supported by the side wall 631. The expanded front frame portion 1101 may be disposed such that, when viewed from a front side of the electronic device 100, a portion of the side wall 631 supporting the expanded front frame portion 1101 is covered by the expanded front frame portion 1101.

As a non-limiting example, the front frame portion 634 and the expanded front frame portion 1101 may define a step portion 1105, as in a state 1100. The step portion 1105 may include a horizontal portion 1102 that is a portion of the expanded front frame portion 1101, a horizontal portion 1104 that is a portion of the front frame portion 634, and a vertical portion 1103 that connects the horizontal portion 1104 to the horizontal portion 1102. As a non-limiting example, the step portion 1105 may be a structure for replacing the damper 600.

For example, when the third housing part 130 is supported by the front frame portion 614 of the first housing part 110 according to the second housing part 120 partially folded with respect to the first housing part 110 and the third housing part 130, the front frame portion 634 can be spaced apart from the front frame portion 614 of the first housing part 110 by the expanded front frame portion 1101 that is contacted on the front frame portion 614 of the first housing part 110.

For example, the expanded front frame portion 1101 may be contacted on a first portion 1001 of the front frame portion 615 of the first housing part 110, when the third housing part 130 is positioned on a portion of the foldable display 140 positioned above the first housing part 110, according to the second housing part 120 partially folded with respect to the first housing part 110 and the third housing part 130.

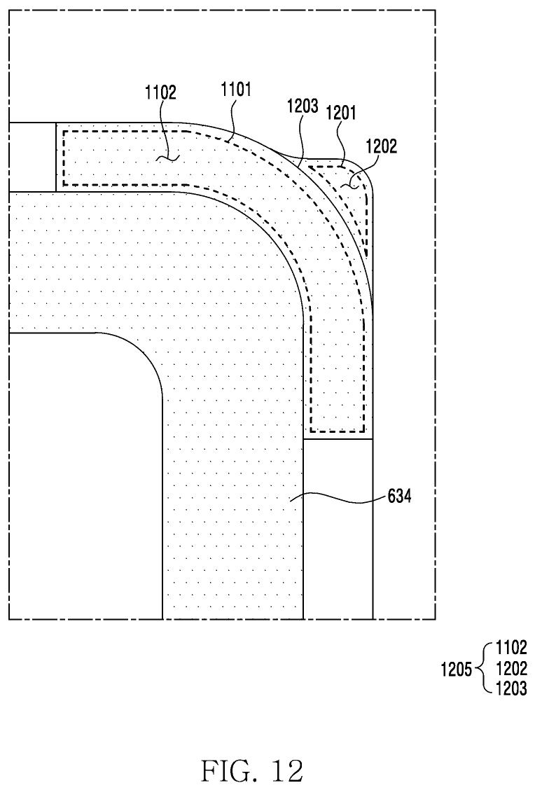

FIG. 12 illustrates a second example configuration of an expanded front frame portion in a third housing part of an electronic device.

Referring to FIG. 12, an expanded front frame portion 1201 according to the second example configuration may be expanded from the expanded front frame portion 1101 according to the first example configuration illustrated in FIG. 11.

As a non-limiting example, the expanded front frame portion 1101 and the expanded front frame portion 1201 may define a step portion 1205. The step portion 1205 may include a horizontal portion 1102 that is a portion of the expanded front frame portion 1101, a horizontal portion 1202 that is a portion of the expanded frame portion 1201, and a vertical portion 1203 that connects the horizontal portion 1202 to the horizontal portion 1102. As a non-limiting example, the step portion 1205 may be a structure for replacing the damper 600.

For example, the front frame portion 634 and/or the expanded front frame portion 1101 may be spaced apart from the front frame portion 614 of the first housing part 110 by the expanded front frame portion 1201 that is contacted on the front frame portion 614 of the first housing part 110, when the third housing part 130 is supported by the front frame portion 614 of the first housing part 110 according to the second housing part 120 partially folded with respect to the first housing part 110 and the third housing part 130.

For example, the expanded front frame portion 1201 may be contacted on the first portion 1001 of the front frame portion 615 of the first housing part 110, when the third housing part 130 is positioned on a portion of the foldable display 140 positioned above the first housing part 110, according to the second housing part 120 partially folded with respect to the first housing part 110 and the third housing part 130.

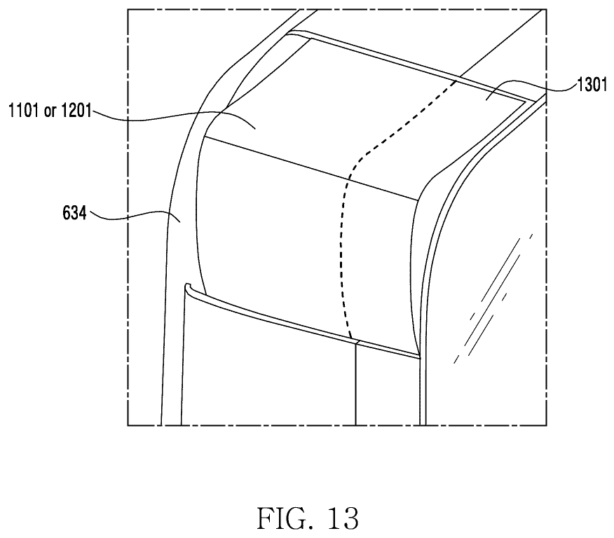

FIG. 13 illustrates a third example configuration of an expanded front frame part in a third housing part of an electronic device.

Referring to FIG. 13, an expanded front frame portion 1301 according to the third example configuration may be expanded (or extended) in a direction of a rear wall of the third housing part 130 from the expanded front frame portion 1101 according to the first example configuration or the expanded front frame portion 1201 according to the second example configuration.

As a non-limiting example, the side wall 631 included within the rounded corner portion 696 by the expanded front frame portion 1301 may be (fully) covered.

For example, the front frame portion 634 and/or the expanded front frame portion 1101 may be spaced apart from the front frame portion 614 of the first housing part 110 by the expanded front frame portion 1301 (or the expanded front frame portion 1201 and the expanded front frame portion 1301) that is contacted on the front frame portion 614 of the first housing part 110, when the third housing part 130 is supported by the front frame portion 614 of the first housing part 110 according to the second housing part 120 partially folded with respect to the first housing part 110 and the third housing part 130.

For example, the expanded front frame portion 1301 (or the expanded front frame portion 1201 and the expanded front frame portion 1301) may be contacted on the first portion 1001 of the front frame portion 615 of the first housing part 110, when the third housing part 130 is positioned on a portion of the foldable display 140 positioned above the first housing part 110 according to the second housing part 120 partially folded with respect to the first housing part 110 and the third housing part 130.

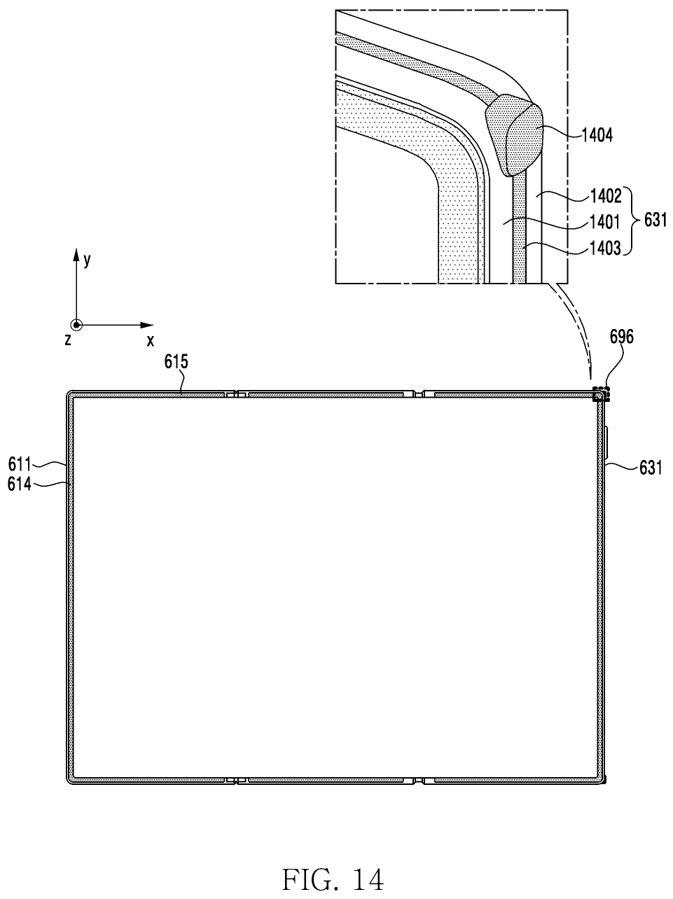

FIG. 14 illustrates an example configuration of a side frame portion included in a third housing part of an electronic device.

Referring to FIG. 14, the side wall 631 may include a first conductive portion 1401, a second conductive portion 1402, and a side frame portion 1403. The side frame portion 1403 may be a non-conductive portion. The side frame portion 1403 may be disposed between the first conductive portion 1401 and the second conductive portion 1402. The first conductive portion 1401, the second conductive portion 1402, and the side frame portion 1403 may be attached to the first conductive portion 1401 and the second conductive portion 1402 of the side wall 631, through an injection process. For example, the side frame portion 1403 attached to the first conductive portion 1401 and the second conductive portion 1402 may be provided, by injecting a molten resin forming the side frame portion 1403 into a mold into which the first conductive portion 1401 and the second conductive portion 1402 are inserted, and curing the molten resin injected into the mold.

The side frame portion 1403 may include a protruding portion 1404 disposed within the rounded corner portion 696.

For example, the front frame portion 634 may be spaced apart from the front frame portion 614 of the first housing part 110 by the protruding portion 1404, when the third housing part 130 is supported by the front frame portion 614 of the first housing part 110 according to the second housing part 120 partially folded with respect to the first housing part 110 and the third housing part 130.

For example, the protruding portion 1404 may be contacted on the first portion 1001 of the front frame portion 615 of the first housing part 110, when the third housing part 130 is positioned on a portion of the foldable display 140 positioned above the first housing part 110 according to the second housing part 120 partially folded with respect to the first housing part 110 and the third housing part 130.

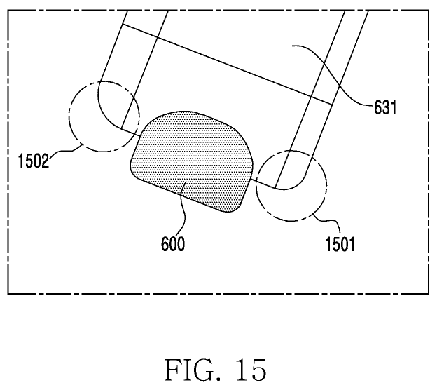

FIG. 15 illustrates a size of a damper included in a third housing part of an electronic device that omits a front frame part.

Referring to FIG. 15, front frame portions (e.g., front frame portions of the first housing part 110, front frame portions of the second housing part 120, and front frame portions of the third housing part 130) covering the periphery of the foldable display 140 may be omitted from the electronic device 100.

The side wall 631 may include edge portions 1503 connected to the side wall 632 (not illustrated in FIG. 15). The edge portions 1503 may be positioned within the rounded corner portion 696. The edge portions 1503 may include a first edge portion 1501 and a second edge portion 1502. The first edge portion 1501 may be closer to a front wall (or front surface) of the third housing part 130 than the second edge portion 1502. The second edge portion 1502 may be closer to a rear wall (or rear surface) of the third housing part 130 than the first edge portion 1501.

For example, the first edge portion 1501 may be spaced apart from the edge portion of the side wall 611 of the first housing part 110 by the damper 600 contacted on the edge portion of the side wall 611 of the first housing part 110, when the third housing part 130 is supported by an edge portion (e.g., an edge portion adjacent to the front wall (or front surface) of the first housing part 110) of the side wall 611 of the first housing part 110 according to the second housing part 120 partially folded with respect to the first housing part 110 and the third housing part 130.

For example, the damper 600 may be contacted on the side wall 612 of the first housing part 110 (or only on the side wall 612 of the first housing part 110), when the third housing part 130 is positioned on a portion of the foldable display 140 positioned above the first housing part 110 according to the second housing part 120 partially folded with respect to the first housing part 110 and the third housing part 130.

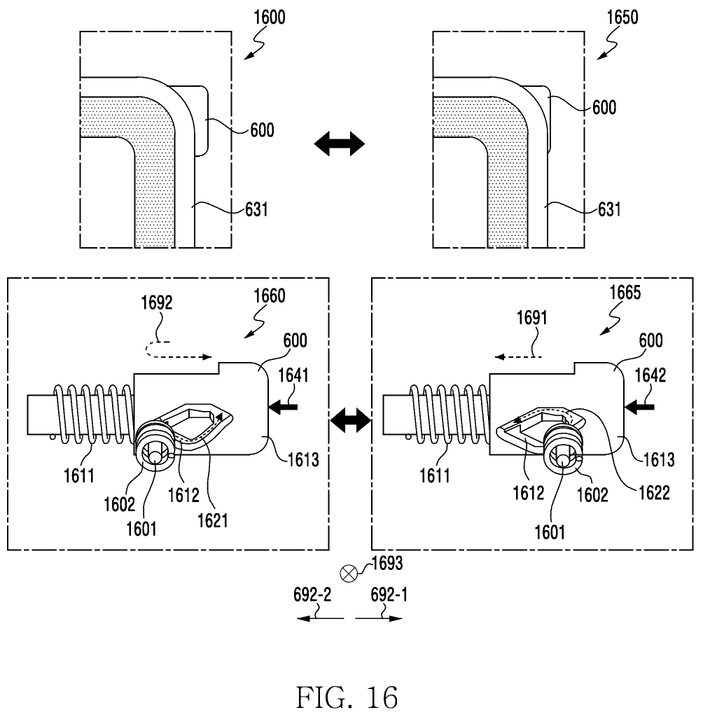

FIG. 16 illustrates a damper capable of being inserted into a third housing part of an electronic device.

Referring to FIG. 16, at least a portion of the damper 600 may be insertable into the side wall 631.

The damper 600, which is insertable into the side wall 631 (or the third housing part 130), may be in a state 1600 that is more protruded from the side wall 631 or in a state 1650 that is more inserted into the side wall 631.

For the damper 600 that is insertable into the side wall 631 (or the third housing part 130), a push latch structure may be applied.

The damper 600 may include a body portion 1613 and an elastic body (or spring) 1611.

The elastic body 1611 may cause the damper 600 to move in the direction 692-1, in response to a release of a force 1641 in the direction 692-2, which causes the damper 600 to move in the direction 692-2 within the state 1600. The elastic body 1611 may cause a movement 1692 of the damper 600, which includes a first movement of the damper 600 in the direction 692-2 and a second movement of the damper 600 in the direction 692-1 (which is a movement of the damper 600 after the first movement).

The body portion 1613 may include a cam 1612 (or a guide groove 1612). The guide groove 1612 may guide a movement path of a cam follower 1601 included in the third housing part 130. The third housing part 130 may include an elastic body 1602 (or a spring 1602) that covers at least a portion of the cam follower 1601 and provides a force in a direction 1693.

For example, based on the force 1641 provided to the damper 600 and a release of the force 1641 within a state 1660 corresponding to the state 1600, the cam follower 1601 may be moved along a movement path 1621. For example, the cam follower 1601 moved along the movement path 1621 may be in a state 1665 changed from the state 1660. When the cam follower 1601 is in the state 1665, the damper 600 may be further inserted into the side wall 631 or the third housing part 130, as in the state 1650.

For example, based on the force 1642 provided to the damper 600 in the state 1665 corresponding to the state 1650, the cam follower 1601 may be moved along a movement path 1622. For example, the cam follower 1601 moved along the movement path 1622 may be in a state 1660 changed from the state 1665. When the cam follower 1601 is in the state 1660, the damper 600 may be more protruded from the side wall 631 or the third housing part 130, as in the state 1600.

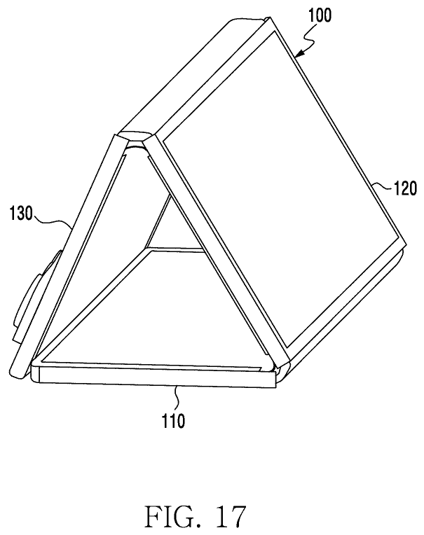

The electronic device 100 may be intended to have a single triangular prism shape. In relation to the electronic device 100 having the single triangular prism shape, a structure included within the electronic device 100 is described with reference to FIGS. 17 to 23.

FIG. 17 illustrates a third housing part of an electronic device configured to be detachably attached to a first housing part of an electronic device.

Referring to FIG. 17, the electronic device 100 may have a single triangular prism shape, such as the illustration of FIG. 17. The electronic device 100 may have the single triangular prism shape by a third housing part 130 detachably attached to the first housing part 110. For example, the electronic device 100 may have the single triangular prism shape according to detachably attaching a portion (e.g., at least a portion of the front frame portion 634, or at least a portion of the side wall 631) of the third housing part 130 to the side wall 611 of the first housing part 110.

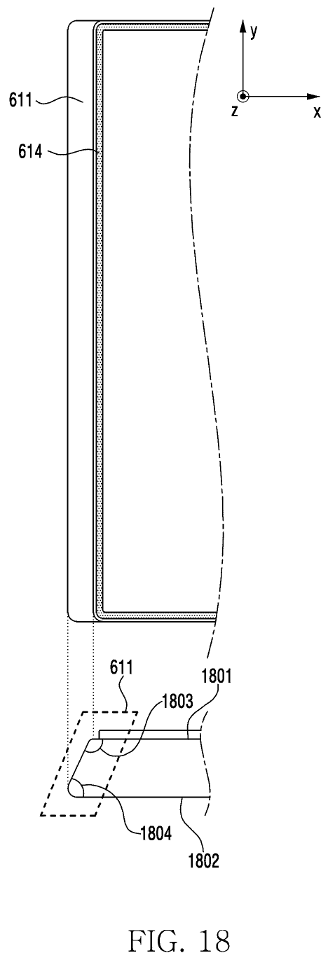

The side wall 611 may have a structure for attaching the portion of the third housing part 130. The structure is described with reference to FIG. 18.

FIG. 18 illustrates a shape of a side wall of a first housing part of an electronic device.

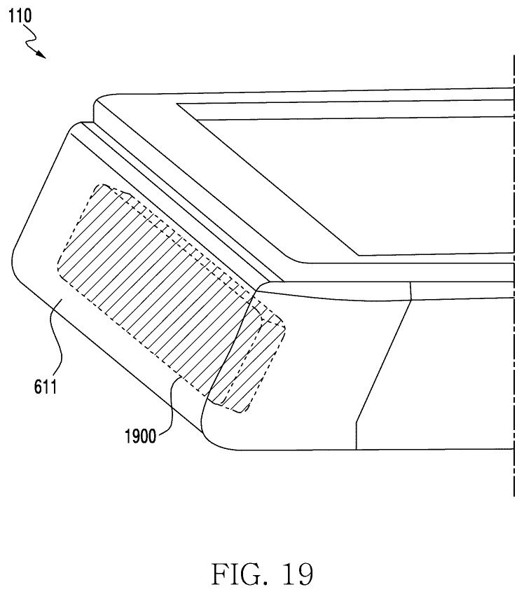

Referring to FIG. 18, the first housing part 110 may include an inclined side wall 611 as the structure for attaching the portion of the third housing part 130. The first housing part 110 may include a front surface face 1801 and a rear surface 1802 wider than the front surface 1801. Since the front surface 1801 is narrower than the rear surface 1802, the side wall 611 extending from the front surface 1801 to the rear surface 1802 may be inclined. For example, an angle 1803 between the front surface 1801 and an outer surface of the side wall 611 may be an interior angle, and an angle 1804 between the rear surface 1802 and the outer surface of the side wall 611 may be an exterior angle. The angle 1803 and the angle 1804 may determine the single triangular prism shape. The first housing part 110 may further include an additional structure for detachably attaching the portion of the third housing part 130. The additional structure may be disposed in relation to the side wall 611. The additional structure may be paired with the portion of the third housing part 130. The additional structure is described with reference to FIG. 19.

FIG. 19 illustrates a magnet included in a first housing part of an electronic device.

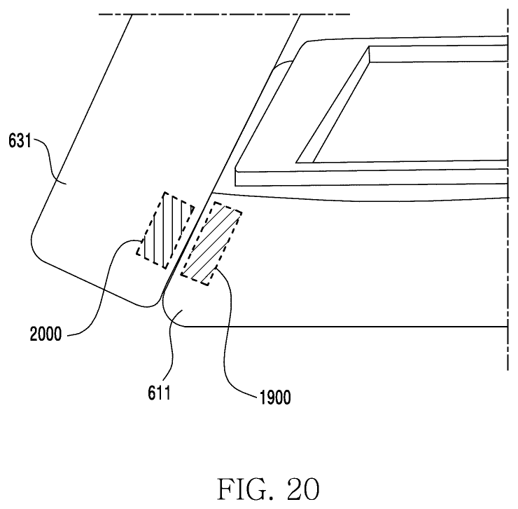

Referring to FIG. 19, the first housing part 110 may include a magnet 1900 adjacent to the side wall 611. The magnet 1900 may be included within the first housing part 110 to be invisible from the outside. The magnet 1900 may be paired with a magnet included within the third housing part 130. The magnet included within the third housing part 130 is described with reference to FIG. 20.

FIG. 20 illustrates a magnet in a third housing part of an electronic device paired with a magnet included in a first housing part of the electronic device.

Referring to FIG. 20, the third housing part 130 may include a magnet 2000 adjacent to the side wall 631. The magnet 2000 may be included within the third housing part 130 to be invisible from the outside. A polarity of the magnet 2000 may be opposite to a polarity of the magnet 1900. For example, the single triangular prism shape of the electronic device 100 may be determined by an attractive force between the magnet 1900 and the magnet 2000, a position of the magnet 1900, and a position of the magnet 2000.

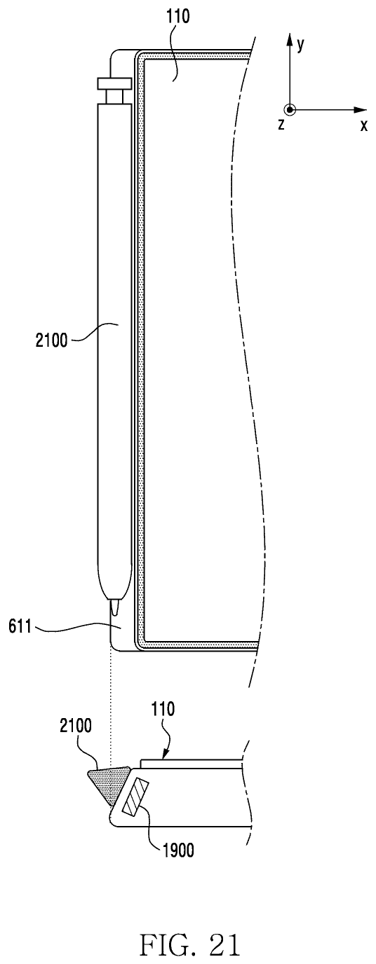

The magnet 1900 may be used not only for the electronic device 100 having the single triangular prism shape, but also for detachably attaching an accessory device. The accessory device is described with reference to FIG. 21.

FIG. 21 illustrates a stylus configured to be detachably attached through a magnet included in a first housing part of an electronic device.

Referring to FIG. 21, the accessory device (or peripheral device) may further include a stylus 2100 (or an electromagnetic pen 2100). The stylus 2100 may be used to provide a handwriting input through the foldable display 140. The stylus 2100 may provide the handwriting input by providing an electromagnetic signal to the foldable display 140 according to an active electrostatic (AES) method, a capacitive method, and/or an electromagnetic resonance (EMR) method.

The stylus 2100 may include a magnet paired with the magnet 1900. The magnet may be disposed within a body portion of the stylus 2100 to be invisible from the outside of the stylus 2100. For example, a polarity of the magnet of the stylus 2100 may be opposite to the polarity of the magnet 1900. For example, a position at which the stylus 2100 is detachably attached to the side wall 611 may be determined by an attractive force between the magnet 1900 and the magnet of the stylus 2100, a position of the magnet 1900, and a position of the magnet of the stylus 2100.

For the third housing part 130 detachably attached to the first housing part 110, the first housing part 110 may include a structure that replaces the structure illustrated in FIGS. 19 to 21, or a structure that is additionally applied in relation to the structure illustrated in FIGS. 19 to 21.

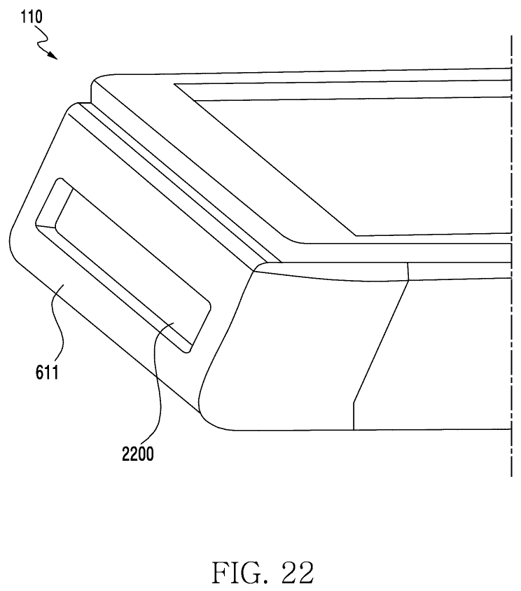

FIG. 22 illustrates a groove included in a first housing part of an electronic device.

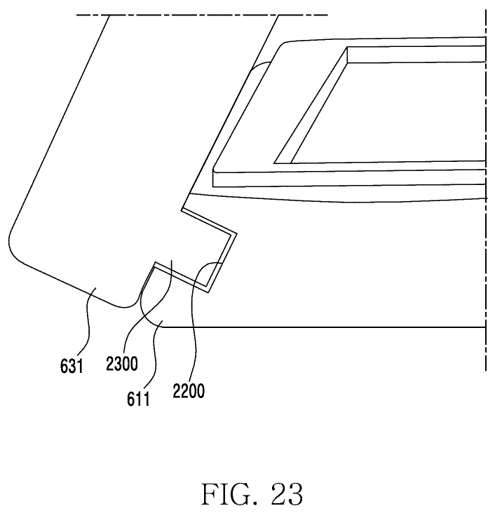

Referring to FIG. 22, the first housing part 110 may include, within the side wall 611, a groove portion 2200 for detachably attaching the third housing part 130 to the side wall 611 of the first housing part 110, either to replace the magnet 1900 or together with the magnet 1900. The groove portion 2200 may be paired with a structure included within the third housing part 130. The structure is described with reference to FIG. 23.

FIG. 23 illustrates a protruding portion of a third housing part of an electronic device paired with a groove included in a first housing part of the electronic device.

Referring to FIG. 23, the third housing part 130 may include, within the side wall 613, a protruding portion 2300 for detachably attaching the third housing part 130 to the side wall 611 of the first housing part 110, either to replace the magnet 2000 or together with the magnet 2000. A shape and size of the protruding portion 2300 may correspond to the shape and size of a groove portion 2200.

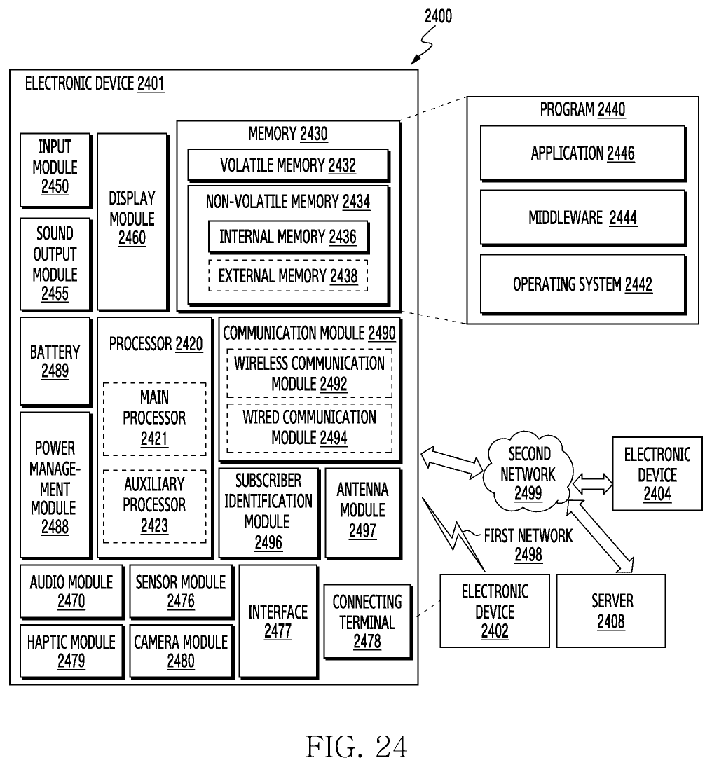

As described above, the electronic device 100 may include at least a portion of the electronic device 2401 of FIG. 24.

FIG. 24 is a block diagram illustrating an electronic device 2401 in a network environment 2400 according to various embodiments. Referring to FIG. 24, the electronic device 2401 in the network environment 2400 may communicate with an electronic device 2402 via a first network 2498 (e.g., a short-range wireless communication network), or at least one of an electronic device 2404 or a server 2408 via a second network 2499 (e.g., a long-range wireless communication network). According to an embodiment, the electronic device 2401 may communicate with the electronic device 2404 via the server 2408. According to an embodiment, the electronic device 2401 may include a processor 2420, memory 2430, an input module 2450, a sound output module 2455, a display module 2460, an audio module 2470, a sensor module 2476, an interface 2477, a connecting terminal 2478, a haptic module 2479, a camera module 2480, a power management module 2488, a battery 2489, a communication module 2490, a subscriber identification module (SIM) 2496, or an antenna module 2497. In some embodiments, at least one of the components (e.g., the connecting terminal 2478) may be omitted from the electronic device 2401, or one or more other components may be added in the electronic device 2401. In some embodiments, some of the components (e.g., the sensor module 2476, the camera module 2480, or the antenna module 2497) may be implemented as a single component (e.g., the display module 2460).

The processor 2420 may execute, for example, software (e.g., a program 2440) to control at least one other component (e.g., a hardware or software component) of the electronic device 2401 coupled with the processor 2420, and may perform various data processing or computation. According to an embodiment, as at least part of the data processing or computation, the processor 2420 may store a command or data received from another component (e.g., the sensor module 2476 or the communication module 2490) in volatile memory 2432, process the command or the data stored in the volatile memory 2432, and store resulting data in non-volatile memory 2434. According to an embodiment, the processor 2420 may include a main processor 2421 (e.g., a central processing unit (CPU) or an application processor (AP)), or an auxiliary processor 2423 (e.g., a graphics processing unit (GPU), a neural processing unit (NPU), an image signal processor (ISP), a sensor hub processor, or a communication processor (CP)) that is operable independently from, or in conjunction with, the main processor 2421. For example, when the electronic device 2401 includes the main processor 2421 and the auxiliary processor 2423, the auxiliary processor 2423 may be adapted to consume less power than the main processor 2421, or to be specific to a specified function. The auxiliary processor 2423 may be implemented as separate from, or as part of the main processor 2421.

The auxiliary processor 2423 may control at least some of functions or states related to at least one component (e.g., the display module 2460, the sensor module 2476, or the communication module 2490) among the components of the electronic device 2401, instead of the main processor 2421 while the main processor 2421 is in an inactive (e.g., sleep) state, or together with the main processor 2421 while the main processor 2421 is in an active state (e.g., executing an application). According to an embodiment, the auxiliary processor 2423 (e.g., an image signal processor or a communication processor) may be implemented as part of another component (e.g., the camera module 2480 or the communication module 2490) functionally related to the auxiliary processor 2423. According to an embodiment, the auxiliary processor 2423 (e.g., the neural processing unit) may include a hardware structure specified for artificial intelligence model processing. An artificial intelligence model may be generated by machine learning. Such learning may be performed, e.g., by the electronic device 2401 where the artificial intelligence is performed or via a separate server (e.g., the server 2408). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 2430 may store various data used by at least one component (e.g., the processor 2420 or the sensor module 2476) of the electronic device 2401. The various data may include, for example, software (e.g., the program 2440) and input data or output data for a command related thereto. The memory 2430 may include the volatile memory 2432 or the non-volatile memory 2434.

The program 2440 may be stored in the memory 2430 as software, and may include, for example, an operating system (OS) 2442, middleware 2444, or an application 2446.

The input module 2450 may receive a command or data to be used by another component (e.g., the processor 2420) of the electronic device 2401, from the outside (e.g., a user) of the electronic device 2401. The input module 2450 may include, for example, a microphone, a mouse, a keyboard, a key (e.g., a button), or a digital pen (e.g., a stylus pen).

The sound output module 2455 may output sound signals to the outside of the electronic device 2401. The sound output module 2455 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 2460 may visually provide information to the outside (e.g., a user) of the electronic device 2401. The display module 2460 may include, for example, a display, a hologram device, or a projector and control circuitry to control a corresponding one of the display, hologram device, and projector. According to an embodiment, the display module 2460 may include a touch sensor adapted to detect a touch, or a pressure sensor adapted to measure the intensity of force incurred by the touch.

The audio module 2470 may convert a sound into an electrical signal and vice versa. According to an embodiment, the audio module 2470 may obtain the sound via the input module 2450, or output the sound via the sound output module 2455 or a headphone of an external electronic device (e.g., an electronic device 2402) directly (e.g., wiredly) or wirelessly coupled with the electronic device 2401.

The sensor module 2476 may detect an operational state (e.g., power or temperature) of the electronic device 2401 or an environmental state (e.g., a state of a user) external to the electronic device 2401, and then generate an electrical signal or data value corresponding to the detected state. According to an embodiment, the sensor module 2476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2477 may support one or more specified protocols to be used for the electronic device 2401 to be coupled with the external electronic device (e.g., the electronic device 2402) directly (e.g., wiredly) or wirelessly. According to an embodiment, the interface 2477 may include, for example, a high definition multimedia interface (HDMI), a universal serial bus (USB) interface, a secure digital (SD) card interface, or an audio interface.

A connecting terminal 2478 may include a connector via which the electronic device 2401 may be physically connected with the external electronic device (e.g., the electronic device 2402). According to an embodiment, the connecting terminal 2478 may include, for example, an HDMI connector, a USB connector, a SD card connector, or an audio connector (e.g., a headphone connector).

The haptic module 2479 may convert an electrical signal into a mechanical stimulus (e.g., a vibration or a movement) or electrical stimulus which may be recognized by a user via his tactile sensation or kinesthetic sensation. According to an embodiment, the haptic module 2479 may include, for example, a motor, a piezoelectric element, or an electric stimulator.

The camera module 2480 may capture a still image or moving images. According to an embodiment, the camera module 2480 may include one or more lenses, image sensors, image signal processors, or flashes.

The power management module 2488 may manage power supplied to the electronic device 2401. According to an embodiment, the power management module 2488 may be implemented as at least part of, for example, a power management integrated circuit (PMIC).

The battery 2489 may supply power to at least one component of the electronic device 2401. According to an embodiment, the battery 2489 may include, for example, a primary cell which is not rechargeable, a secondary cell which is rechargeable, or a fuel cell.

The communication module 2490 may support establishing a direct (e.g., wired) communication channel or a wireless communication channel between the electronic device 2401 and the external electronic device (e.g., the electronic device 2402, the electronic device 2404, or the server 2408) and performing communication via the established communication channel. The communication module 2490 may include one or more communication processors that are operable independently from the processor 2420 (e.g., the application processor (AP)) and supports a direct (e.g., wired) communication or a wireless communication. According to an embodiment, the communication module 2490 may include a wireless communication module 2492 (e.g., a cellular communication module, a short-range wireless communication module, or a global navigation satellite system (GNSS) communication module) or a wired communication module 2494 (e.g., a local area network (LAN) communication module or a power line communication (PLC) module). A corresponding one of these communication modules may communicate with the external electronic device via the first network 2498 (e.g., a short-range communication network, such as Bluetooth™, wireless-fidelity (Wi-Fi) direct, or infrared data association (IrDA)) or the second network 2499 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 2492 may identify and authenticate the electronic device 2401 in a communication network, such as the first network 2498 or the second network 2499, using subscriber information (e.g., international mobile subscriber identity (IMSI)) stored in the subscriber identification module 2496.

The wireless communication module 2492 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 2492 may support a high-frequency band (e.g., the mmWave band) to achieve, e.g., a high data transmission rate. The wireless communication module 2492 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 2492 may support various requirements specified in the electronic device 2401, an external electronic device (e.g., the electronic device 2404), or a network system (e.g., the second network 2499). According to an embodiment, the wireless communication module 2492 may support a peak data rate (e.g., 20 Gbps or more) for implementing eMBB, loss coverage (e.g., 2464 dB or less) for implementing mMTC, or U-plane latency (e.g., 0.5 ms or less for each of downlink (DL) and uplink (UL), or a round trip of 24 ms or less) for implementing URLLC.

The antenna module 2497 may transmit or receive a signal or power to or from the outside (e.g., the external electronic device) of the electronic device 2401. According to an embodiment, the antenna module 2497 may include an antenna including a radiating element composed of a conductive material or a conductive pattern formed in or on a substrate (e.g., a printed circuit board (PCB)). According to an embodiment, the antenna module 2497 may include a plurality of antennas (e.g., array antennas). In such a case, at least one antenna appropriate for a communication scheme used in the communication network, such as the first network 2498 or the second network 2499, may be selected, for example, by the communication module 2490 (e.g., the wireless communication module 2492) from the plurality of antennas. The signal or the power may then be transmitted or received between the communication module 2490 and the external electronic device via the selected at least one antenna. According to an embodiment, another component (e.g., a radio frequency integrated circuit (RFIC)) other than the radiating element may be additionally formed as part of the antenna module 2497.

According to various embodiments, the antenna module 2497 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 2401 and the external electronic device 2404 via the server 2408 coupled with the second network 2499. Each of the electronic devices 2402 or 2404 may be a device of a same type as, or a different type, from the electronic device 2401. According to an embodiment, all or some of operations to be executed at the electronic device 2401 may be executed at one or more of the external electronic devices 2402, 2404, or 2408. For example, if the electronic device 2401 should perform a function or a service automatically, or in response to a request from a user or another device, the electronic device 2401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 2401. The electronic device 2401 may provide the outcome, with or without further processing of the outcome, as at least part of a reply to the request. To that end, a cloud computing, distributed computing, mobile edge computing (MEC), or client-server computing technology may be used, for example. The electronic device 2401 may provide ultra low-latency services using, e.g., distributed computing or mobile edge computing. In another embodiment, the external electronic device 2404 may include an internet-of-things (IoT) device. The server 2408 may be an intelligent server using machine learning and/or a neural network. According to an embodiment, the external electronic device 2404 or the server 2408 may be included in the second network 2499. The electronic device 2401 may be applied to intelligent services (e.g., smart home, smart city, smart car, or healthcare) based on 5G communication technology or IoT-related technology.

As described above, an electronic device (e.g., the electronic device 100) may comprise a housing (e.g., the housing 101). The housing may include a first housing part (e.g., the first housing part 110), a second housing part (e.g., the second housing part 120) rotatably coupled with respect to the first housing part, and a third housing part (e.g., the third housing part 130) rotatably coupled with respect to the second housing part. The first housing part may be configured to be positioned between the second housing part and the third housing part when the electronic device is in a multi-folded state. The electronic device may include a foldable display (e.g., the foldable display 140) disposed to overlie the first housing part, the second housing part, and the third housing part. The first housing part may include a side wall (e.g., the side wall 611) defining a portion of a periphery of the electronic device, and a protection member (e.g., the front frame portion 614) disposed at an edge of the foldable display. The third housing part may include a side wall (e.g., the side wall 631) parallel to the side wall of the first housing part, at least one camera disposed on a rear surface of the third housing part, at least one input member disposed on the side wall of the third housing part, and a buffer member (e.g., the damper 600 and the damper 601) disposed on the side wall of the third housing part. The buffer member may include a first buffer member disposed at a first position of the side wall of the third housing part and a second buffer member disposed at a second position of the side wall of the third housing part. The first buffer member and the second buffer member may be configured to be protruded from the side wall of the third housing part.

The third housing part may include a protection member supported by the side wall of the third housing part and disposed at an edge of the foldable display. The electronic device may have a triangular prism shape when the third housing part is supported by the protection member of the first housing part according to the first housing part, the second housing part, and the third housing part, which are partially folded. The protection member of the third housing part may be spaced apart from the protection member of the first housing part by the buffer member contacted on the protection member of the first housing part, when the third housing part is supported by the protection member of the first housing part.

The at least one input member of the third housing part may include a button (e.g., the button 683) protruded from the side wall of the third housing part. The buffer member may be more protruded from the side wall of the third housing part than the button.

The side wall of the third housing part may include a dented portion (e.g., the dented portion 800). The button may be protruded from the dented portion of the side wall of the third housing part.

The portion of the side wall of the third housing part may correspond to a rounded corner portion (e.g., the rounded corner portion 696) of the electronic device. The side wall of the third housing part may further include another portion (e.g., the portion 681) corresponding to a planar portion of a lateral surface of a rounded cuboid. The buffer member may be protruded from the portion of the side wall of the third housing part in a direction of the other portion of the side wall of the third housing part.

The first housing part may include another side wall (e.g., the side wall 612) and another protection member (e.g., the front frame portion 615), defining a portion of the periphery of the electronic device. The other protection member may include a first portion (e.g., the first portion 1001) supported by the other side wall of the first housing part, and a second portion (e.g., the second portion 1002) extending from the first portion of the other protection member and covering the edge of the foldable display. The buffer member protruded from the portion of the side wall of the third housing part may contacted on the first portion of the other protection member of the first housing part, when the third housing part is positioned on a portion of the foldable display positioned above the first housing part, according to the second housing part partially folded with respect to the first housing part and the third housing part.

The buffer member may be formed from a rubber.

The buffer member may be formed from a urethane.

The buffer member may be formed from a silicon.

The side wall of the third housing part may include a groove portion (e.g., the groove portion 900). The buffer member protruded from the portion of the side wall of the third housing part may include a portion positioned within the groove portion of the side wall of the third housing part.

As described above, an electronic device (e.g., the electronic device 100) may comprise a housing (e.g., the housing 101). The housing may include a first housing part (e.g., the first housing part 110), a second housing part (e.g., the second housing part 120) rotatably coupled with the first housing part, and a third housing part (e.g., the third housing part 130) rotatably coupled with the second housing part. The first housing part may be configured to be positioned between the second housing part and the third housing part when the electronic device is in a multi-folded state. The electronic device may comprise a foldable display (e.g., the foldable display 140) disposed above the first housing part, the second housing part, and the third housing part. The first housing part may include a first side wall (e.g., the side wall 611) defining a portion of a periphery of the electronic device, a second side wall (e.g., the side wall 612) defining a portion of the periphery of the electronic device and perpendicular to the first side wall of the first housing part, a first protection member (e.g., the front frame portion 614) supported by the first side wall of the first housing part and covering a portion of a periphery of the foldable display, and a second protection member (e.g., the front frame portion 615). The second protection member may include a first portion (e.g., the first portion 1001) supported by the second side wall of the first housing part, and a second portion (e.g., the second portion 1002) extending from the first portion of the second protection member and covering a portion of the periphery of the foldable display. The third housing part may include a side wall (e.g., the side wall 631) defining a portion of the periphery of the electronic device and parallel to the first side wall of the first housing part, a protection member (e.g., the front frame portion 634) supported by the side wall of the third housing part and covering a portion of the periphery of the foldable display, and a buffer member (e.g., the damper 600) protruded in a direction of the side wall of the third housing part. The buffer member may be contacted on the first portion of the second protection member of the first housing part, when the third housing part is positioned on a portion of the foldable display positioned above the first housing part, according to the second housing part partially folded with respect to the first housing part and the third housing part.

The buffer member may be protruded from a portion of the side wall of the third housing part.

The electronic device may have a triangular prism shape when the third housing part is positioned on the portion of the foldable display.

The portion of the side wall of the third housing part may correspond to a rounded corner portion of the electronic device. The side wall of the third housing part may include another portion corresponding to a planar portion of a lateral surface of a rounded cuboid. The buffer member may be protruded from the portion of the side wall of the third housing part in the other direction of the other portion of the side wall of the third housing part.

The protection member of the third housing part may be spaced apart from the first protection member of the first housing part by the buffer member contacted on the first protection member of the first housing part, when the third housing part is supported by the front frame portion of the first housing part according to the second housing part partially folded with respect to the first housing part and the third housing part.

The third housing part may include a button protruded from the side wall of the third housing part. The damper may be more protruded from the side wall of the third housing part than the button.

The side wall of the third housing part may include a dented portion. The button may be protruded from the dented portion of the side wall of the third housing part.

The buffer member may be formed from a rubber.

The buffer member may be formed from a urethane.

The buffer member may be formed from a silicon.

The third housing part may include a groove portion. The buffer member protruded from the portion of the side wall of the third housing part may include a portion positioned within the groove portion of the third housing part.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

It will be understood that the terms “includes,” “comprises,” “has,” “having,” “including,” “comprising,” and the like when used in this specification, specify the presence of stated features, figures, steps, operations, components, members, or combinations thereof, but do not preclude the presence or addition of one or more other features, figures, steps, operations, components, members, or combinations thereof. An expression that one component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component. It will also be understood that when one component is referred to as being “on” or “over” another component, it may be directly on the other component or intervening components may also be present.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 2440) including one or more instructions that are stored in a storage medium (e.g., internal memory 2436 or external memory 2438) that is readable by a machine (e.g., the electronic device 2401). For example, a processor (e.g., the processor 2420) of the machine (e.g., the electronic device 2401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An electronic device comprising:
a housing comprising:
a first housing part,
a second housing part rotatably coupled to the first housing part, and
a third housing part rotatably coupled to the second housing part,
wherein the first housing part is positioned between the second housing part and the third housing part when the electronic device is in a multi-folded state; and
a foldable display disposed above the first housing part, the second housing part, and the third housing part;
wherein the first housing part comprises:
a side wall defining a portion of a periphery of the electronic device, and
a protection member covering a portion of a periphery of the foldable display, and
wherein the third housing part comprises:
a side wall, defining a portion of the periphery of the electronic device, parallel to the side wall of the first housing part,
a protection member covering a portion of the periphery of the foldable display, and
a buffer member protruding from a portion of the side wall of the third housing part.

2. The electronic device of claim 1, wherein, when the third housing part is supported by the protection member of the first housing part, the protection member of the third housing part is spaced apart from the protection member of the first housing part by the buffer member contacted on the protection member of the first housing part.

3. The electronic device of claim 2, wherein the housing has a triangular prism shape when the third housing part is supported by the protection member of the first housing part.

4. The electronic device of claim 2, wherein the third housing part further comprises a button protruding from the side wall of the third housing part, and
wherein the buffer member is protruding further from the side wall of the third housing part than the button.

5. The electronic device of claim 4, wherein the side wall of the third housing part further comprises a dented portion, and
wherein the button protrudes from the dented portion of the side wall of the third housing part.

6. The electronic device of claim 2, wherein the portion of the side wall of the third housing part comprises a rounded corner portion of the electronic device,
wherein the side wall of the third housing part further includes another portion corresponding to a planar portion of a lateral surface of a rounded cuboid, and
wherein the buffer member is protruded from the portion of the side wall of the third housing part in a direction of the other portion of the side wall of the third housing part.

7. The electronic device of claim 6, wherein the first housing part further comprises:
another side wall, defining a portion of the periphery of the electronic device; and
another protection member including:
a first portion supported by the other side wall of the first housing part, and
a second portion, extending from the first portion of the other protection member, covering a portion of the periphery of the foldable display, and
wherein, when the third housing part is positioned on a portion of the foldable display positioned above the first housing part in accordance with the second housing part partially folded with respect to both the first housing part and the third housing part, the buffer member, protruded from the portion of the side wall of the third housing part, is contacted on the first portion of the other protection member of the first housing part.

8. The electronic device of claim 7, wherein, when the third housing part is positioned on a portion of the foldable display positioned above the first housing part in accordance with the second housing part partially folded with respect to both the first housing part and the third housing part, the buffer member, protruded from the portion of the side wall of the third housing part, is spaced apart from the second portion of the other protection member of the first housing part.

9. The electronic device of claim 7, wherein the other protection member of the first housing part is substantially perpendicular to the protection member of the first housing part.

10. The electronic device of claim 1, wherein the buffer member comprises a rubber.

11. The electronic device of claim 1, wherein the buffer member comprises a urethane.

12. The electronic device of claim 1, wherein the buffer member comprises a silicon.

13. The electronic device of claim 1, wherein the side wall of the third housing part further comprises a groove portion, and
wherein a portion of the buffer member, protruded from the portion of the side wall of the third housing part, is in the groove portion of the side wall of the third housing part.

14. The electronic device of claim 1, wherein the protection member of the first housing part is on the side wall of the first housing part.

15. The electronic device of claim 1, wherein the protection member of the third housing part is on the side wall of the third housing part.

16. An electronic device comprising:
a housing comprising:
a first housing part,
a second housing part rotatably coupled to the first housing part, and
a third housing part rotatably coupled to the second housing part, wherein the first housing part is positioned between the second housing part and the third housing part when the electronic device is in a multi-folded state; and
a foldable display disposed above the first housing part, the second housing part, and the third housing part,
wherein the first housing part comprises:
a first side wall defining a portion of a periphery of the electronic device;
a second side wall, defining a portion of the periphery of the electronic device, perpendicular to the first side wall of the first housing part;
a first protection member, supported by the first side wall of the first housing part, covering a portion of a periphery of the foldable display; and
a second protection member including:
a first portion supported by the second side wall of the first housing part, and
a second portion, extending from the first portion of the second protection member, covering a portion of the periphery of the foldable display,
wherein the third housing part comprises:
a side wall, defining a portion of the periphery of the electronic device, parallel to the first side wall of the first housing part,
a protection member, supported by the side wall of the third housing part, covering a portion of the periphery of the foldable display, and
a buffer member protruded in a direction of the side wall of the third housing part, and
wherein, when the third housing part is positioned on a portion of the foldable display disposed above the first housing part in accordance with the second housing part partially folded with respect to both the first housing part and the third housing part, the buffer member is contacted on the first portion of the second protection member of the first housing part.

17. The electronic device of claim 16, wherein, when the third housing part is supported by the first protection member of the first housing part in accordance with the second housing part partially folded with respect to both the first housing part and the third housing part, the protection member of the third housing part is spaced apart from the first protection member of the first housing part by the buffer member contacted on the first protection member of the first housing part.

18. The electronic device of claim 17, wherein the third housing part further comprises a button protruding from the side wall of the third housing part, and
wherein the buffer member protrudes further from the side wall of the third housing part than the button.

19. The electronic device of claim 18, wherein the side wall of the third housing part further comprises a dented portion, and
wherein the button is protruded from the dented portion of the side wall of the third housing part.

20. The electronic device of claim 16, wherein the buffer member comprises a rubber, a urethane, and/or a silicon.
